(19) United States
(12) Patent Application Publication
(10) Pub. No.: US 2026/0194368 A1
(43) Pub. Date: Jul. 9, 2026

(54) SENSOR AND METHOD FOR RELATIVE MOTION DETECTION

(71) Applicant: Nanyang Technological University, Singapore (SG)

(72) Inventors: Qing ZHANG, Singapore (SG); Yin SUN, Singapore (SG); Ran XU, Singapore (SG); Joseph Sylvester CHANG, Singapore (SG)

(73) Assignee: Nanyang Technological University, Singapore (SG)

(21) Appl. No.: 18/853,077

(22) PCT Filed: Mar. 30, 2023
(86) PCT No.: PCT/SG2023/050214

§ 371 Date: Sep. 30, 2024

(30) Foreign Application Priority Data
Mar. 30, 2023 (SG) 10202203249Y

(51) Int. Cl. G01D 5/20; G01P 13/00

(52) U.S. Cl. CPC G01D 5/20; G01P 13/00

(57) ABSTRACT

According to embodiments of the present invention, there is provided a sensor including: a primary sensing part including a first electrode and a second electrode electrically coupled to the first electrode; a secondary sensing part including a third electrode and a fourth electrode electrically coupled to the third electrode; and electrical measurement unit(s). The first, second, third, and fourth electrodes respectively include a first material, a second material, a third material, and a fourth material. The first and/or second electrodes and third and/or fourth electrodes may be arranged to move relatively to each other to generate electrical signal(s) representative of quantifiable parameter(s) of relative motion. According to further embodiments, a method for determining quantifiable parameter(s) of relative motion between a movable object and a stationary (or another movable) object is also provided.

### CROSS-REFERENCE TO RELATED APPLICATION

This application claims the benefit of priority of Singapore patent application No. 10202203249Y, filed 30 Mar. 2022, the content of it being hereby incorporated by reference in its entirety for all purposes.

### TECHNICAL FIELD

Various embodiments relate to a sensor, more specifically, a relative motion sensor, and a method for determining at least one quantifiable parameter of relative motion between a primary sensing part of the sensor and a secondary sensing part of the sensor.

### BACKGROUND

Detection of relative motions, including vibration frequencies, amplitudes and directions, amongst others is in high demand in many fields as vibrations usually originate from machinery wear and tear and misalignment.

Vibrations may be detected using several well-established methods, including piezoelectric, electrostatic, magnetic, and optical techniques. In a piezoelectric accelerometer, a piezoelectric element is sandwiched between a seismic mass and a structure base. When vibration is applied through the base, the force of inertia of the mass introduces a strain to the piezoelectric element, producing a piezoelectric signal that is a function of the vibration frequency, amplitude, and so on. As the piezoelectric element is subject to the mechanical impact, a drastic impact might damage it. Thus, the reliability of the piezoelectric element is obviously a potential drawback. As the piezoelectric element installed on a vibrational part, it is not capable of detecting the gap width between the vibrational part and a stationary part.

A variable capacitance accelerometer includes a pair of parallel electrodes under a voltage difference. One of the electrodes is attached to a flexible reed and the other is fixed to a stationary part. The configuration forms an air gap capacitor between the two electrodes. When vibration occurs, the air gap or the capacitance varies to generate an alternating current, AC, if the two electrodes are biased. The AC provides the information of vibration frequency and amplitude or the transient gap width. Variable capacitance accelerometers are of high sensitivity, generating a high output even at a low frequency. However, an external voltage is to be maintained between the two electrodes. Alternatively, a layer of electret may be introduced to one of the electrodes or the two electrodes may be of distinct work functions, φ₂ and φ₁, where a built-in potential difference qV₁₂=φ₂−φ₁ exists in between the two electrodes once they are connected electrically. When the movable electrode vibrates, an AC is created in the external circuit. As the two electrodes are connected electrically, the variable capacitance accelerometers are not capable of eccentricity detection.

To monitor the working status of a rotor or the gap between a rotor and a stator, variable magnetic fields and magnetic sensors, including Hall effect sensors, linear variable differential transformers (LVDTs) and eddy current sensors, amongst others are widely employed in the industry.

A Hall effect sensor consists merely of a rectangular semiconductor slab with a continuous current passing through it. When the Hall effect sensor is subject to the variable magnetic field, the Hall voltage is generated and it is highly sensitive to the strength of the magnetic field. By attaching a permanent magnet to a rotor or one side of a variable gap and placing the semiconductor slab on the stationary part or the other part of the gap, the Hall voltage may be detected, and it is a sensitive function of the gap width.

In an LVDT, a primary movable wire coil around a piece of magnetically permeable material may be suspended in between a pair of identical secondary wire coils which is fixed on a stationary part. In operation, a constant amplitude alternating current is supplied to the primary coil to create a magnetic field so that the magnetic flux through the permeable material is coupled to the two adjacent secondary wire coils. If the primary coil is out of the midway between the two secondary wire coils, a differential electromotive force, emf, in the two secondary wire coils is created and used to monitor the motions of the primary coil. The output usually requires no amplification, but the coils have to be encapsulated to prevent against moisture but remain magnetically permeable. LVDTs are popular for detection of vibrations larger than 4 mm. For smaller vibrations, eddy current sensors are more commonly used.

An eddy current sensor consists merely of a wire coil. A high-frequency magnetic field is generated by feeding a high-frequency current to the wire coil. When a moving conductive object is within the magnetic field, an eddy current is induced in the object, and then produces a magnetic flux that in turn increases the impedance of the wire coil. From the resultant oscillation signals, the vibration amplitude and frequency may be deduced. Magnetic field-based sensors are immune to temperature variation. However, one needs to maintain high-frequency currents through the wire coils, which is costly and inconvenient, especially for on-site monitoring. In addition, the measurements usually show large drift, where compensation is regularly required. Moreover, to ensure the maximum sensitivity, the sensing surface needs to be maintained perpendicular to the magnetic field. As a result, constant calibration may be required throughout the period of time when such magnetic field-based sensors are in use.

Light beam position sensors and optical mice are the two major optical sensors to detect relative motions. A light beam position sensor measures the light beam positions. A change in the light beam position tells the relative motions between the position sensor and the light source or the object which reflects the light beam. The beam position sensors are of high sensitivity and able to detect static and dynamic relative positions. However, a high level of optical alignment may be required when using the beam position sensors. Beam position sensors are insensitive to the motions along the light beam. An optical mouse processes the optical flow of the mouse pad images taken by the optical mouse to determine the relative motion between the optical mouse and mouse pad. Although optical mice are user-friendly, they require a flat mouse pad to create clear images and in terms of image processing, they may not be feasible for fast and real-time monitoring.

Thus, there is a need for a novel/improved method and apparatus for on-site monitoring of relative motions between two objects, including, but not limited to detections of the relative motion speed, vibration amplitude and frequency, the transient gap width, rotor eccentricity, amongst others, that address at least the problems mentioned above.

### SUMMARY

According to an embodiment, a sensor is provided. The sensor may include a primary sensing part including a first electrode and a second electrode electrically coupled to the first electrode, wherein the first electrode includes a first material and the second electrode includes a second material; a secondary sensing part including a third electrode and a fourth electrode electrically coupled to the third electrode, wherein the third electrode includes a third material, and the fourth electrode includes a fourth material; the first material, the second material, the third material and the fourth material being either different from one another or the same; and one or more electrical measurement units each electrically coupled to: the third electrode, or the fourth electrode, or both the third electrode and the fourth electrode, or the first electrode, or the second electrode, or both the first electrode and the second electrode; wherein the primary sensing part and the secondary sensing part are free from electrical connection with each other; and wherein at least one of the first electrode or the second electrode of the primary sensing part and at least one of the third electrode or the fourth electrode of the secondary sensing part are arranged to move relatively to each other to generate one or more electrical signals measurable by the one or more electrical measurement units, the generated one or more electrical signals being representative of at least one quantifiable parameter of relative motion between the primary sensing part and the secondary sensing part.

According to an embodiment, a method for determining at least one quantifiable parameter of relative motion between a movable object and a stationary object or another movable object is provided. The method may include providing a sensor. The sensor may include a primary sensing part including a first electrode and a second electrode electrically coupled to the first electrode, wherein the first electrode includes a first material and the second electrode includes a second material; a secondary sensing part including a third electrode and a fourth electrode electrically coupled to the third electrode, wherein the third electrode includes a third material, and the fourth electrode includes a fourth material; the first material, the second material, the third material and the fourth material being either different from one another or the same; and one or more electrical measurement units each electrically coupled to: the third electrode, or the fourth electrode, or both the third electrode and the fourth electrode, or the first electrode, or the second electrode, or both the first electrode and the second electrode, wherein the primary sensing part and the secondary sensing part are free from electrical connection with each other. The method may further include attaching at least one portion of the primary sensing part to the movable object; attaching at least one portion of the secondary sensing part to the stationary object or the other movable object with the third electrode positioned facing towards the second electrode of the primary sensing part, or with the fourth electrode positioned facing towards the first electrode of the primary sensing part; and measuring, by the one or more electrical measurement units, one or more electrical signals generated in the sensor, wherein the generated one or more electrical signals are representative of the at least one quantifiable parameter of relative motions between the primary sensing part and the secondary sensing part.

### BRIEF DESCRIPTION OF THE DRAWINGS

In the drawings, like reference characters generally refer to like parts throughout the different views. The drawings are not necessarily to scale, emphasis instead generally being placed upon illustrating the principles of the invention. In the following description, various embodiments of the invention are described with reference to the following drawings, in which:

FIG. 1A shows a schematic view of a sensor, according to various embodiments.

FIG. 1B shows a flow chart illustrating a method for determining at least one quantifiable parameter of relative motion between a movable object and a stationary object or another movable object, according to various embodiments.

FIG. 2A shows a schematic view of two exemplary metal electrodes with different work functions, along with the energy band diagram when the two electrodes are not connected.

FIG. 2B shows a schematic view of the two exemplary metal electrodes of FIG. 2A, along with the energy band diagram after the two electrodes are electrically connected.

FIG. 3 shows a schematic view of an elementary structure of the sensor, according to one example.

FIG. 4 shows a schematic view of a structure of a sensor adapted from the sensor of FIG. 3 involving two electrical measurement units being electrically coupled between a secondary pair of electrodes and a ground, according to one example.

FIG. 5 shows a schematic view of a structure of a sensor reconfigured from the sensor of FIGS. 3 and 4 involving an electrical measurement unit being electrically coupled between a secondary pair of electrodes with a lower work function electrode of the secondary pair being grounded, according to one example.

FIG. 6 shows a schematic view of a structure of a sensor reconfigured from the sensor of FIGS. 3 and 4 involving an electrical measurement unit being electrically coupled between a secondary pair of electrodes with a higher work function electrode of the secondary pair being grounded, according to one example.

FIG. 7 shows a schematic view of the sensor of FIG. 3 where all four electrodes are coated with passivation layers, according to one example.

FIG. 8 shows a schematic view of the sensor of FIG. 7 where all four electrodes are coated with passivation layers, with built-in potential difference multipliers, BPDM, being introduced to a primary pair of electrodes and a secondary pair of electrodes, according to one example.

FIG. 9A shows an expanded schematic view of the BPDM introduced to the primary pair of electrodes of FIG. 8, in the form of more components (or multiple couples) coupled in series with insulating spacers, according to one example.

FIG. 9B shows an expanded schematic view of the BPDM of FIG. 9A, additionally with conductive interlayers included, according to one example.

FIG. 10 shows an expanded schematic view of the BPDM introduced to the primary pair of electrodes of FIG. 8, in the form of multiple diodes coupled in series, according to one example.

FIG. 11 shows an expanded schematic view of the BPDM introduced to the primary pair of electrodes of FIG. 8, in the form of multiple batteries or capacitors coupled in series, according to one example.

FIG. 12A shows an expanded schematic view of the BPDM introduced to the secondary pair of electrodes of FIG. 8 via the electrical measurement unit, in the form of more components (or multiple couples) coupled in series with insulating spacers, according to one example.

FIG. 12B shows an expanded schematic view of the BPDM of FIG. 12A, additionally with conductive interlayers included, according to one example.

FIG. 13 shows an expanded schematic view of the BPDM introduced to the secondary pair of electrodes of FIG. 8 via the electrical measurement unit, in the form of multiple diodes coupled in series, according to one example.

FIG. 14 shows an expanded schematic view of the BPDM introduced to the secondary pair of electrodes of FIG. 8 via the electrical measurement unit, in the form of multiple batteries (or rechargeable batteries) or capacitors coupled in series, according to one example.

FIG. 15 shows a schematic view of a structure of the sensor adapted from that of FIG. 4 with BPDMs included, according to one example.

FIG. 16 shows a schematic view of a structure of the sensor adapted or reconfigured from those of FIGS. 5 and 15, according to one example.

FIG. 17 shows a schematic view of a structure of the sensor adapted or reconfigured from those of FIGS. 6 and 15, according to one example.

FIG. 18 shows a schematic view illustrating an exemplary arrangement where a sensor is used to monitor the linear motion speed of a movable object with respect to another object and the gap width between them.

FIG. 19 shows a schematic view illustrating an exemplary arrangement where a sensor is used to monitor the eccentricity in the horizontal direction and the rotation speed of a rotor.

FIG. 20A shows a schematic view illustrating an exemplary arrangement where a sensor is used to monitor the eccentricity in both horizontal direction and vertical direction, as well as the rotation speed of a rotor.

FIG. 20B shows a schematic view illustrating another or alternative exemplary arrangement where the sensor is used to monitor the eccentricity in both horizontal direction and vertical direction, as well as the rotation speed of the rotor.

FIGS. 21A to 21D show schematic views illustrating different exemplary arrangements where a sensor is used to monitor the vibration amplitude and frequency of a vibrational beam with respect to another object.

FIGS. 22A to 22C show schematic views illustrating the relative positions of AL and AH electrodes with respect to BL and BH electrodes with the electrical measurement unit coupled therebetween, according to one example.

FIG. 22D shows a graph illustrating the transient current generated during the relative motion depicted in FIGS. 22A to 22C.

FIGS. 23A and 23C show schematic views illustrating the relative positions of AL and AH electrodes with respect to BL and BH electrodes with the electrical measurement unit coupled therebetween, according to one example.

FIGS. 23B and 23D show graphs illustrating the transient current generated during the relative motion corresponding to the schematic views of FIGS. 23A and 23C, respectively.

FIGS. 24A, 24C and 24E show schematic views illustrating the relative positions of AL and AH electrodes with respect to BL and BH electrodes with the electrical measurement unit coupled therebetween, according to one example.

FIGS. 24B, 24D and 24F show graphs illustrating the transient current generated during the relative motion corresponding to the schematic views of FIGS. 24A, 24C and 23E, respectively.

FIGS. 25A, 25C and 25E show schematic views illustrating the electrode installation to a rotor and a stator and demonstrating the effect of eccentricity of the rotor, according to one example.

FIGS. 25B, 25D and 25F shows graphs illustrating the transient current generated during the relative motion corresponding to the schematic views of FIGS. 25A, 25C. and 25E, respectively.

FIG. 26A shows a schematic view illustrates a set-up of the electrode installation to a rotor and a stator and demonstrating the effect of different rotational or spinning speeds of the rotor, according to one example.

FIGS. 26B to 26F show graphs illustrating the generated transient current in response to the spinning speed of the rotor increasing from 30 rpm to 300 rpm based on the setup of FIG. 26A.

FIG. 27A shows a schematic view depicting a setup with no BPDM attached to the electrode pairs, according to one example.

FIG. 27C shows a schematic view depicting a setup with a BPDM constituting one metal couple attached to the moveable (inner) electrode pair, according to another example.

FIG. 27E shows a schematic view depicting a setup with a BPDM constituting two metal couples attached to the moveable (inner) electrode pair, according to yet another example.

FIGS. 27B, 27D, and 27F show graphs illustrating the generated transient currents in the stationary pair electrodes corresponding to FIGS. 27A, 27C and 27E, respectively.

FIG. 28A shows a schematic view depicting a setup with no BPDM attached to any of the electrode pairs, according to one example.

FIG. 28C shows a schematic view depicting a setup with a BPDM constituting one metal couple attached to the moveable electrode pair that is attached to a rotor, according to another example.

FIG. 28E shows a schematic view depicting a setup with a BPDM constituting two metal couples attached to the moveable electrode pair that is attached to a rotor, according to yet another example.

FIG. 28G shows a schematic view depicting a setup with a BPDM constituting three metal couples attached to the moveable electrode pair that is attached to a rotor, according to a further example.

FIGS. 28B, 28D, 28F and 28H show graphs illustrating the generated transient currents in the stationary pair electrodes corresponding to FIGS. 28A, 28C, 28E and 28G, respectively.

FIG. 29A shows a schematic view depicting a setup with no BPDM attached to any of the electrode pairs, according to one example.

FIG. 29C shows a schematic view depicting a setup with a BPDM constituting one diode attached to the moveable electrode pair that is attached to a rotor, according to another example.

FIG. 29E shows a schematic view depicting a setup with a BPDM constituting two diodes attached to the moveable electrode pair that is attached to a rotor, according to yet another example.

FIG. 29G shows a schematic view depicting a setup with a BPDM constituting three diodes attached to the moveable electrode pair that is attached to a rotor, according to a further example.

FIGS. 29B, 29D, 29F and 29H show graphs illustrating the generated transient currents in the stationary pair electrodes corresponding to FIGS. 29A, 29C, 29E and 29G, respectively.

FIG. 30A shows a schematic view depicting a setup with no BPDM attached to any of the electrode pairs, according to one example.

FIG. 30C shows a schematic view depicting a setup with a BPDM constituting one battery attached to the moveable electrode pair that is attached to a rotor, according to another example.

FIG. 30E shows a schematic view depicting a setup with a BPDM constituting two batteries attached to the moveable electrode pair that is attached to a rotor, according to yet another example.

FIGS. 30B, 30D, and 30F show graphs illustrating the generated transient currents in the stationary pair electrodes corresponding to FIGS. 30A, 30C, and 30E, respectively.

FIG. 31A shows a schematic view depicting a setup with no BPDM attached to any of the electrode pairs, according to one example.

FIG. 31C shows a schematic view depicting a setup with a BPDM constituting one AA battery attached to the moveable pair of electrodes, according to another example.

FIG. 31E shows a schematic view depicting a setup with a BPDM constituting two AA batteries attached to the moveable pair of electrodes, according to yet another example.

FIGS. 31B, 31D, and 31F show graphs illustrating the generated transient currents between the stationary electrode and the ground corresponding to FIGS. 31A, 31C, and 31E, respectively.

FIG. 32A shows a schematic view depicting a setup with no BPDM attached to any of the electrode pairs, according to one example.

FIG. 32C shows a schematic view depicting a setup with a BPDM constituting one AA battery attached to the stationary electrode, according to another example.

FIG. 32E shows a schematic view depicting a setup with a BPDM constituting two AA batteries attached to the stationary electrode, according to yet another example.

FIGS. 32B, 32D, and 32F show graphs illustrating the generated transient currents between the stationary electrode and the ground corresponding to FIGS. 32A, 32C, and 32E, respectively.

FIG. 33A shows a schematic view depicting a setup with a BPDM constituting one AA battery attached to the stationary electrode and another BPDM constituting one AA battery attached to the moveable electrode pair, according to one example.

FIG. 33C shows a schematic view depicting a setup with a BPDM constituting two AA batteries attached to the stationary electrode and another BPDM constituting one AA battery attached to the moveable electrode pair, according to another example.

FIG. 33E shows a schematic view depicting a setup with a BPDM constituting one AA battery attached to the stationary electrode and another BPDM constituting two AA batteries attached to the moveable electrode pair, according to yet another example.

FIG. 33G shows a schematic view depicting a setup with a BPDM constituting two AA batteries attached to the stationary electrode and another BPDM constituting two AA batteries attached to the moveable electrode pair, according to a further example.

FIGS. 33B, 33D, 33F and 33H show graphs illustrating the generated transient currents between the stationary electrode and the ground corresponding to FIGS. 33A, 33C, 33E, and 33G, respectively.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

Embodiments described in the context of one of the methods or devices are analogously valid for the other methods or devices. Similarly, embodiments described in the context of a method are analogously valid for a device, and vice versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance.

As used herein, the term “and/or” includes any and all combinations of one or more of the associated listed items.

As used herein, the phrase of the form of “at least one of A or B” may include A or B or both A and B. Correspondingly, the phrase of the form of “at least one of A or B or C”, or including further listed items, may include any and all combinations of one or more of the associated listed items.

As used herein, the expression “configured to” may mean “constructed to” or “arranged to”.

Various embodiments may provide a sensor, more specifically a relative motion sensor, and a method involving the same. The novel sensor is able to detect the relative motion of a primary sensing part with respect to a secondary sensing part. Along with the method, the sensor may find a broad spectrum of applications, including determination of relative motion speed, vibration amplitude and frequency, transient gap width between the two parts, eccentricity of a rotor, amongst others, without or with using external power.

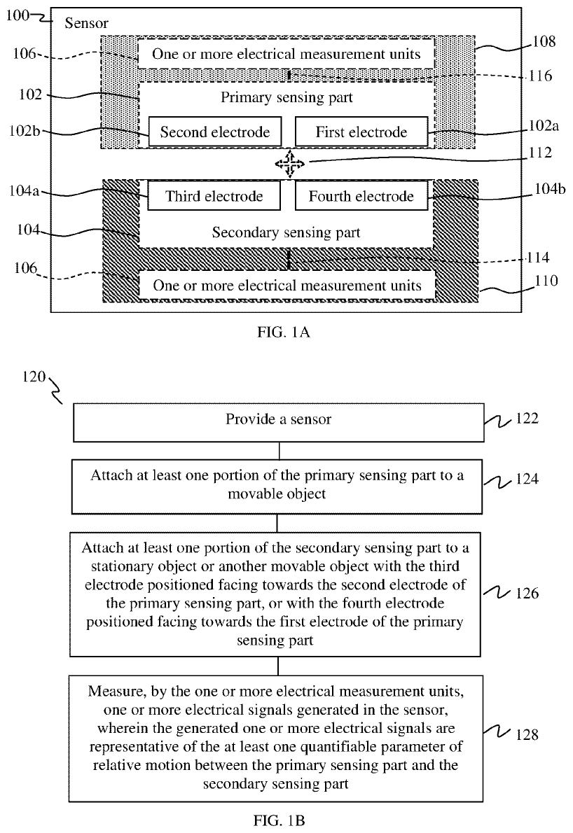

FIG. 1A shows a schematic view of a sensor 100, according to various embodiments. The sensor 100 may include a primary sensing part 102 including a first electrode 102a and a second electrode 102b electrically coupled to the first electrode 102a; a secondary sensing part 104 including a third electrode 104a and a fourth electrode 104b electrically coupled to the third electrode 104a; and one or more electrical measurement units 106 each electrically coupled to the third electrode 104a, or the fourth electrode 104b, or both the third electrode 104a and the fourth electrode 104b (as denoted by line 114), or the first electrode 102a, or the second electrode 102b, or both the first electrode 102a and the second electrode 102b (as denoted by line 116). The first electrode 102a may include a first material and the second electrode 102b may include a second material. The third electrode 104a may include a third material, and the fourth electrode 104b may include a fourth material. The first material, the second material, the third material and the fourth material may be either different from one another or the same. The primary sensing part 102 and the secondary sensing part 104 are free from electrical connection with each other. At least one of the first electrode 102a or the second electrode 102b of the primary sensing part 102 and at least one of the third electrode 104a or the fourth electrode 104b of the secondary sensing part 104 are arranged to move relatively to each other (as represented by a directional arrow 112) to generate one or more electrical signals measurable by the one or more electrical measurement units 106, the generated one or more electrical signals being representative of at least one quantifiable parameter of relative motion between the primary sensing part 102 and the secondary sensing part 104.

For example, the one or more electrical measurement units 106 may be an electrical measurement unit electrically coupled to the third electrode 104a, and/or an electrical measurement unit electrically coupled to the fourth electrode 104b, or an electrical measurement unit electrically coupled between the third electrode 104a and the fourth electrode 104b. In other examples, the one or more electrical measurement units 106 may be an electrical measurement unit electrically coupled to the first electrode 102a, and/or an electrical measurement unit electrically coupled to the second electrode 102b, or an electrical measurement unit electrically coupled between the first electrode 102a and the second electrode 102b. In yet other example, the one or more electrical measurement units 106 may be an electrical measurement unit electrically coupled to the third electrode 104a, and/or an electrical measurement unit electrically coupled to the fourth electrode 104b, and another electrical measurement unit electrically coupled to the first electrode 102a, and/or another electrical measurement unit electrically coupled to the second electrode 102b; or an electrical measurement unit electrically coupled between the third electrode 104a and the fourth electrode 104b, and another electrical measurement unit electrically coupled between the first electrode 102a and the second electrode 102b.

Each of the one or more electrical measurement units 106 may include an ammeter or a current detector, a current preamplifier, a voltmeter, a voltage detector or a voltage amplifier, amongst others. For example, each of the one or more electrical signals may include one or more current signals, or one or more voltage signals, or one or more signals caused by the one or more current signals, or the one or more voltage signals, amongst others. The one or more electrical signals may refer to one or more currents, or one or more voltages.

In the context of various embodiments, the phrase “free from electrical connection” means having no electrical connection or no wire connection or electric connection. In other words, there is no electrical conduction path between the primary sensing part 102 and the secondary sensing part 104.

The expression “electrically coupled” means having an electrical conduction path or being in electrically communication. “Electrically coupled” may refer to a direct or indirect electrical connection.

The expression “quantifiable parameter of relative motion” may include relative motion speed, or vibration amplitude, or vibration frequency, or transient gap width between the two parts, eccentricity of a rotor, or others.

In various embodiments, the sensor 100 may include a self-powered sensor. In other embodiments, the sensor 100 may include an externally powered sensor.

The first material may have a first work function and the second material may have a second work function. The third material may have a third work function and the fourth material may have a fourth work function.

In various embodiments, the second work function may be larger or higher than the first work function, and the fourth work function may be larger or higher than the third work function. In other embodiments, the second work function may be the same as the first work function, and the fourth work function may be the same as the third work function. In yet other embodiments, the first, second, third and fourth work functions may be the same.

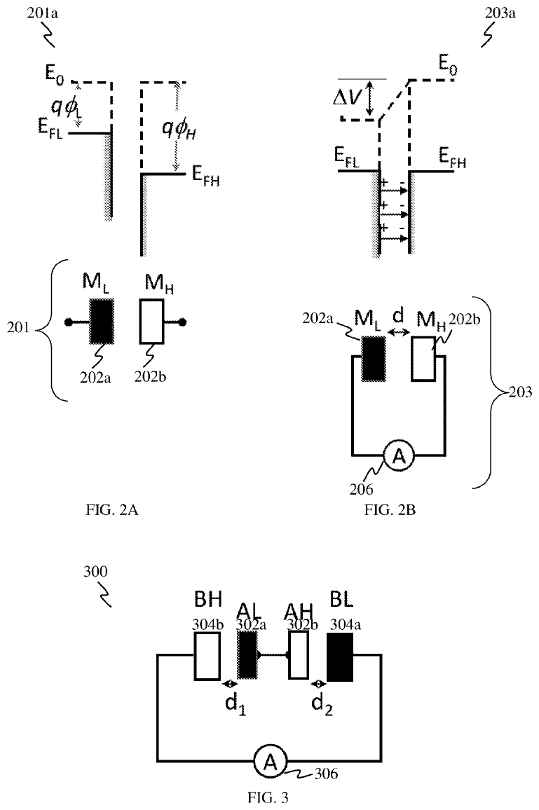

The interaction between two electrodes with different work functions will be explained with respect to FIGS. 2A and 2B illustrating schematic views 201, 203 of two exemplary metal electrodes (M_{L} 202a and M_{H} 202b) with different work functions, along with respective energy band diagram 201a when the two electrodes 202a, 202b are not connected, and energy band diagram 203a after the two electrodes 202a, 202b are electrically connected. As seen in FIG. 2A, the electrode ML 202a (on the left of FIG. 2A) has a lower work function of qφ_{L} (see left side of energy band diagram 201a) and the electrode M_{H} 202b (on the right of FIG. 2A) has a higher work function of qφ_{H} (see right side of energy band diagram 201 a), i.e. q(φ_{H}-φ_{L})>0, where q is the unit charge. E₀ is the vacuum level. E_{FL} and E_{FH} are the Fermi level of the two electrodes 202a, 202b. The two electrodes 202a, 202b are facing towards each other, but are separated with a small gap (d, as shown in the schematic view 203 of FIG. 2B). A built-in electric field pointing from the electrode M_{L} 202a to the electrode M_{H} 202b is established once the two electrodes are connected (see energy band diagram 203a). At thermal equilibrium, a built-in potential difference ΔV =φ_{H}-φ_{L} exists in between the two electrodes 202a, 202b. When one of the electrodes 202a, 202b moves with respect to the other, leading to variation of the gap width d, an alternating current is generated in the wire connection or electric connection and detected by the electrical measurement unit 206.

In one embodiment, the third electrode 104a and the fourth electrode 104b of the secondary sensing part 104, as seen in FIG. 1A may be described in similar context to the schematic view 203 illustrating the two electrodes 202a, 202b being connected, as seen in FIG. 2B.

Each of the first material, the second material, the third material and the fourth material may include metals, or semiconductors, or ferroelectric materials, or pyroelectric materials or a combination of at least one of these materials. Each of the first material, the second material, the third material and the fourth material may be the same or may be different from each other. In other words, each of the first material, the second material, the third material and the fourth material may include at least one metal, or at least one semiconductor, or at least one ferroelectric material, or at least one pyroelectric material, or a combination of the at least one metal, and/or the at least one semiconductor, and/or the at least one ferroelectric material, and/or the at least one pyroelectric material. For example, each of the first work function and the third work function may be less than 4.3 eV. Each of the first material and the third material may include at least one metal, or at least one semiconductor, or at least one ferroelectric material, or at least one pyroelectric material, or a combination of at least one metal and/or at least one semiconductor, and/or at least one ferroelectric material, and/or at least one pyroelectric material. The at least one metal or the at least one semiconductor or the at least one ferroelectric material or the at least one pyroelectric material, having smaller work function, is relatively stable in an ambient environment, and may include aluminium (Al), titanium (Ti), silver (Ag), lead (Pb) or n-type semiconductors. Each of the second work function and the fourth work function may be more than 4.5 eV. Each of the second material and the fourth material may include at least one metal, or at least one semiconductor, or at least one ferroelectric material, or at least one pyroelectric material, or a combination of at least one metal and/or at least one semiconductor and/or at least one ferroelectric material, and/or at least one pyroelectric material. In this case, the at least one metal or the at least one semiconductor, or the at least one ferroelectric material or the at least one pyroelectric material, having larger work function, may include gold (Au), platinum (Pt), nickel (Ni), or p-type semconductors.

It should be noted that the term “metal”, described herein with respect to the sensor 100 according to various embodiment, refer to all types of metallic materials. The metal(s) may be of different dimensionalities and geometries, including in bulk, thin films and an assembly of micro-, nano-sized metallic layers, wires and particles, and so on. They may be hard or flexible.

In the context of various embodiments, the term “semiconductor” means all types of intrinsic and doped semiconducting materials, including inorganic semiconductors and organic semiconductors, regardless of their crystalline or amorphous atomic structures. The semiconductors may be of different dimensionalities and geometries, including in bulk, thin films and an assembly of micro-, nano-sized semiconducting layers, wires and particles, and so on. They may be hard or flexible.

In the context of various embodiments, the term “ferroelectric material” means all types of ferroelectric materials, including inorganic and organic, regardless of their crystalline or amorphous atomic structures. The ferroelectric materials may be of different dimensionalities and geometries, including in bulk, thin films and an assembly of micro-, nano-sized semiconducting layers, wires and particles, and so on. They may be hard or flexible.

In the context of various embodiments, the term “pyroelectric material” means all types of pyroelectric materials, including inorganic and organic, regardless of their crystalline or amorphous atomic structures. The pyroelectric materials may be of different dimensionalities and geometries, including in bulk, thin films and an assembly of micro-, nano-sized semiconducting layers, wires and particles, and so on. They may be hard or flexible.

In various embodiments, each of the first electrode, the second electrode, the third electrode and the fourth electrode may contain more than one material. These materials involved the four electrodes may be different from each other or may be the same correspondingly.

For example for better understanding but not limited to in any way, at least one of the first electrode or the second electrode in the primary sensing part or the third electrode or fourth electrode in the secondary sensing part may be constructed from pure metal plates and semiconductor wafers, or made by depositing pure metallic or doped semiconducting materials onto supporting substrates by physical or chemical processes. The substrates may be insulating, conductive, rigid, flexible, amongst others.

The first material, the second material, the third material and the fourth material may be selected to be any one of the following:
the first material being the same as the third material, and the second material being the same as the fourth material; or
the first material being the same as the third material, and the second material being different from the fourth material; or
the first material being different from the third material, and the second material being the same as the fourth material; or
the first material being different from the third material, and the second material being different from the fourth material.

The selection of the first material, the second material, the third material and the fourth material may affect or may be dependent on the configurations or arrangements of the electrodes 102a, 102b, 104a, 104b. This may be further exemplified in some of the embodiments discussed herein later on below.

In various embodiments, at least one portion of the primary sensing part 102 of the sensor 100 may be arranged to be coupled to a movable object 108, and at least one portion of the secondary sensing part 104 may be arranged to be coupled to a stationary object or another movable object 110.

The at least one portion of the primary sensing part 102 may refer to at least one electrode of the primary sensing part 102, for example, only the first electrode 102a, or only the second electrode 102b, or both the first electrode 102a and the second electrode 102b, or all parts/elements of the primary sensing part 102. The at least one portion of the secondary sensing part 104 may refer to at least one electrode of the secondary sensing part 104, for example, only the third electrode 104a, or only the fourth electrode 104b, or both the third electrode 104a and the fourth electrode 104b, or all parts/elements of the secondary sensing part 104.

In the context of various embodiments, the term “coupled to” may mean connected to, in communication with, attached to, hosted on, or fixed to.

In other words, the sensor 100 includes a primary pair of electrodes 102a, 102b, a secondary pair of electrodes 104a, 104b and one or more electrical measurement units 106. The two electrodes 102a, 102b of the primary pair are connected through a metal wire or electric connection. The two electrodes 104a, 104b are connected with a metal wire or electric connection (e.g. 114) through the one or more electrical measurement units 106. The electrodes 104a, 104b in the secondary pair may (or may not) be the same as those in the primary pair in terms of the materials, dimensions and geometries of the electrodes correspondingly. One (or two) electrode(s) of the primary pair has (have) a relative motion with respect to one (or two) electrode(s) of the secondary pair, but there is no electrical contact between them. For example, the electrical signal may be current or voltage (or may be interchangeably referred to as sensing signal) that is generated when the primary pair of electrodes 102a, 102b has relative motion with respect to the secondary pair of electrodes 104a, 104b. For example, at least one of electrode 102a or electrode 102b in the primary pair may be attached to or hosted on a movable object (e.g. 108). In contrast, at least one of the two electrodes 104a, 104b in the secondary pair may be fixed onto a stationary object or another moveble object (e.g. 110). The basic working principle of the sensing may be as described based on FIGS. 2A and 2B.

Different arrangements of the electrodes may be as described in one of the following, some of which will be further illustrated in the examples provided herein:
First electrode 102a facing to and moving relative to fourth electrode 104b; or
First electrode 102a facing to and moving relative to third electrode 104a; or
Second electrode 102b facing to and moving relative to fourth electrode 104b; or
Second electrode 102b facing to and moving relative to third electrode 104a; or
First electrode 102a facing to and moving relative to fourth electrode 104b, and second electrode 102b facing to and moving relative to third electrode 104a; or
First electrode 102a facing to and moving relative to third electrode 104a, and second electrode 102b facing to and moving relative to fourth electrode 104b.

In various embodiments, the first electrode 102a and the second electrode 102b of the primary sensing part 102 may be positioned at a pre-determined distance apart from each other. The third electrode 104a and the fourth electrode 104b of the secondary sensing part 104 may be positioned at a pre-defined distance apart from each other. In effect, at least one of the first electrode 102a or the second electrode 102b of the primary sensing part 102 is/are configured to collectively move relatively to the third electrode 104a, or the fourth electrode 104b, or both the third electrode 104a and the fourth electrode 104b of the secondary sensing part 104.

Different structures of the sensor 100 and the methodologies for detecting relative motions using the sensor 100 may also be provided according to various embodiments.

In various embodiments, the first electrode 102a may be arranged to be positioned spaced apart from and facing to the fourth electrode 104b, and/or the second electrode 102b may be arranged to be positioned spaced apart from and facing to the third electrode 104a.

Such embodiments may be illustrated in FIG. 3 showing a schematic view of an elementary structure of the sensor 300, according to one example. The sensor 300 may include the same or like elements or components as those of the sensor 100 of FIG. 1A, and as such, the same ending numerals are assigned and the like elements may be as described in the context of the sensor 100 of FIG. 1A, and therefore the corresponding descriptions may be omitted here. In FIG. 3, the sensor 300 includes a primary pair of electrodes (AL 302a and AH 302b), a secondary pair of electrodes (BL 304a and BH 304b) and an electrical measurement unit 306. Electrode AL 302a has a lower work function than Electrode AH 302b. Electrode AL 302a is connected to Electrode AH 302b electrically. Electrode BL 304a has a lower work function than Electrode BH 304b. Electrode BL 304a is connected to Electrode BH 304b through the electrical measurement unit 306 electrically. There is no electrical wire connection or no electrical contact between the primary pair of electrodes 302a, 302b and the secondary pair of electrodes 304a, 304b. Electrode BL 304a in the secondary electrode pair is facing to Electrode AH 302b in the primary electrode pair, while Electrode BH 304b in the secondary electrode pair is facing to Electrode AL 302a in the primary electrode pair. The distance between Electrode AH 302b and Electrode AL 302a in the primary pair may or may not be fixed. The distance between Electrode BH 304b and Electrode BL 304a in the secondary pair may or may not be fixed. The two electrodes of the primary pair of electrodes 302a, 302b are configured to collectively move relatively to the electrodes 304a, 304b in the secondary pair of electrodes. When at least one of the electrodes 302a, 302b in the primary pair moves, or has relative motion with respective to at least one of the electrodes 304a, 304b in the secondary pair, resulting in the variation of gap width d₁ or d₂, alternating currents, AC, or voltages, or electrical signals are generated in each electrode pair. The electrical signal in the secondary pair is measured and it provides the information of the relative motion between the moveable and stationary electrodes.

In various embodiments, one of the one or more electrical measurement units 106 may be electrically coupled between a ground and one of the third electrode 104a or the fourth electrode 104b; and the sensor 100 may further include another of the one or more electrical measurement units 106 electrically coupled between the ground and the other of the third electrode 104a or the fourth electrode 104b.

Such embodiments may be illustrated in FIG. 4 showing a schematic view of a structure of the sensor 400 adapted from the sensor 300 of FIG. 3, according to one example. The sensor 400 may include the same or like elements or components as those of the sensor 100 of FIG. 1A or the sensor 300 of FIG. 3, and as such, the same ending numerals are assigned and the like elements may be as described in the context of the sensor 100 of FIG. 1A or the sensor 300 of FIG. 3, and therefore the corresponding descriptions may be omitted here. In FIG. 4, Electrode BH 404b of the secondary pair is connected to an electrical measurement unit A1 406 and then to the ground 405. Electrode BL 404a of the secondary pair is connected to another electrical measurement unit A2 406′ and then to the ground 405. Similar to that presented in FIG. 3, Electrode BH 404b of the secondary pair is facing towards or to Electrode AL 402a of the primary pair, while Electrode BL 404a of the secondary pair is facing towards or to Electrode AH 402b of the primary pair. The distance between Electrode AH 402b and Electrode AL 402a in the primary pair may or may not be fixed. The distance between Electrode BH 404b and Electrode BL 404a in the secondary pair may or may not be fixed. The two electrodes of the primary pair of electrodes 402a, 402b are configured to collectively move relatively to the two electrodes 404a, 404b in the secondary pair of electrodes. This configuration may allow the electrical measurement unit A1 406 and the other electrical measurement unit A2 406′to measure the electrical signals associated with the variation of gap width d₁ (due to relative motion between Electrode BH 404b and Electrode AL 402a) and the variation of gap width d₂ (due to relative motion between Electrode AH 402b and Electrode BL 404a), respectively.

In alternative or additional embodiments, one of the one or more electrical measurement units 106 may be electrically coupled between a ground and one of the first electrode 102a or the second electrode 102b; and/or another of the one or more electrical measurement units 106 may be electrically coupled between the ground and the other of the first electrode 102a or the second electrode 102b.

In other embodiments, one of the one or more electrical measurement units 106 may be electrically coupled between the third electrode 104a and the fourth electrode 104b; and/or between the first electrode 102a and the second electrode 102b.

Each of the one or more electrical measurement units 106 may condition or may measure or may both condition and measure the generated one or more electrical signals. Each of the one or more electrical measurement units 106 may have either single-ended inputs including an input and the ground, or differential inputs including a non-inverting input and an inverting input. For the single-ended inputs, one of the first electrode 102a or the second electrode 102b may be connected to the input, and the other of the first electrode 102a or the second electrode 102b may be connected to the ground or unconnected, and/or for the single-ended inputs, one of the third electrode 104a or the fourth electrode 104b may be connected to the input, and the other of the third electrode 104a or the fourth electrode 104b may be connected to the ground or unconnected. For the differential inputs, one of the first electrode 102a or the second electrode 102b may be connected to the non-inverting input, and the other of the first electrode 102a or the second electrode 102b may be connected to the inverting input, and/or for the differential inputs, one of the third electrode 104a or the fourth electrode 104b may be connected to the non-inverting input, and the other of the third electrode 104a or the fourth electrode 104b may be connected to the inverting input.

In one embodiment, the first electrode 102a may be arranged to be positioned spaced apart from and facing to the fourth electrode 104b, and the third electrode 104a may be arranged to be connected to a ground.

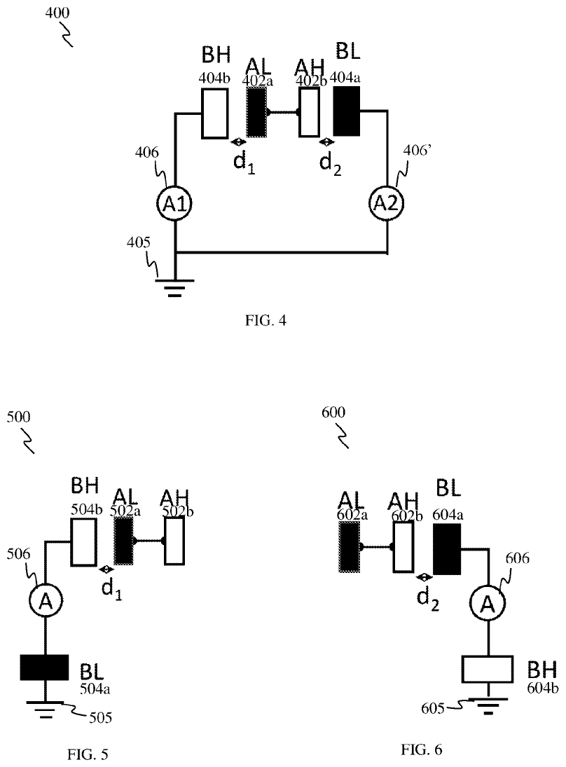

This embodiment may be illustrated in FIG. 5 showing a schematic view of a structure of the sensor 500 reconfigured from the sensor 300, 400 of FIGS. 3 and 4, according to one example. The sensor 500 may include the same or like elements or components as those of the sensor 100 of FIG. 1A or the sensor 300, 400 of FIGS. 3 and 4, and as such, the same ending numerals are assigned and the like elements may be as described in the context of the sensor 100 of FIG. 1A or the sensor 300, 400 of FIG. 3 and 4, and therefore the corresponding descriptions may be omitted here. In FIG. 5, Electrode BH 504b of the secondary pair is facing towards Electrode AL 502a of the primary pair, while Electrode BL 504a, being the lower work function electrode, of the secondary pair is grounded, i.e. connected to the ground 505. In effect, Electrode AH 502b may be not arranged to face to any electrodes 504a, 504b in the secondary pair. An electrical measurement unit 506 is introduced in between the two electrodes 504a, 504b of the secondary pair. The distance between Electrode AH 502b and Electrode AL 502a in the primary pair may or may not be fixed. The two electrodes of the primary pair of electrodes 502a, 502b are configured to collectively move relatively to Electrode BH 504b in the secondary pair of electrodes. This configuration may allow the electrical measurement unit 506 to measure the electrical signal associated with the variation of gap width d₁ (due to relative motion between Electrode AL 502a and Electrode BH 504b).

In one embodiment, the second electrode 102b may be arranged to be positioned spaced apart from and facing to the third electrode 104a, and the fourth electrode 104b is arranged to be connected to a ground.

This embodiment may be illustrated in FIG. 6 showing a schematic view of a structure of the sensor 600 reconfigured from the sensor 300, 400 of FIGS. 3 and 4, according to one example. The sensor 600 may include the same or like elements or components as those of the sensor 100 of FIG. 1A or the sensor 300, 400 of FIGS. 3 and 4, and as such, the same ending numerals are assigned and the like elements may be as described in the context of the sensor 100 of FIG. 1A or the sensor 300, 400 of FIGS. 3 and 4, and therefore the corresponding descriptions may be omitted here. In FIG. 6, Electrode BL 604a of the secondary pair is facing towards Electrode AH 602b of the primary pair, while Electrode BH 604b, being the higher work function electrode, of the secondary pair is grounded, i.e. connected to the ground 605. In effect, Electrode AL 602a may be not arranged to face to any electrodes 604a, 604b in the secondary pair. An electrical measurement unit 606 is introduced in between the two electrodes 604a, 604b of the secondary pair. The distance between Electrode AH 602b and Electrode AL 602a in the primary pair may or may not be fixed. The two electrodes of the primary pair of electrodes 602a, 602b are configured to collectively move relative to Electrode BL 604a in the secondary pair of electrodes. This configuration may allow the electrical measurement unit 606 to measure the electrical signal associated with the variation of gap width d₂ (due to relative motion between Electrode AH 602b and Electrode BL 604a).

In various embodiments, the first electrode 102a, or the second electrode 102b, or both the first electrode 102a and the second electrode 102b each may have a front surface coated with passivation layers, the front surface being a surface arranged to be respectively positioned facing to the fourth electrode 104b, and/or to the third electrode 104a. The passivation leyer coated to the first electrode 102a may or may not be the same as that coated to the second electrode 102b.

In other embodiments, the third electrode 104a, or the fourth electrode 104b, or both the third electrode 104a and the fourth electrode 104b each has a frontal surface coated with passivation layers, the frontal surface being a surface arranged to be respectively positioned facing to the second electrode 102b, and/or to the first electrode 102a. The passivation leyer coated to the third electrode 104a may or may not be the same as that coated to the fourth electrode 104b.

In other embodiments, the passivation layers coated to each of the first, second, third and fourth electrode may be different from each other or may be the same correspondingly. The materials of the passivation layers may be dielectrics, or polymers, or functionalized groups, or metals, or semiconductors, or ferroelectric materials, or pyroelectric materials or a combination of at least one of these materials. Passivation layers may be coated to the surface of the electrodes of the primary pair (e.g. 102a, 102b) and the secondary pair (e.g. 104a, 104b). The passivation layers may reduce the density of surface states of the electrodes, passivate the surfaces of the electrodes from oxidation and/or contamination, enhance the induced electrical signals, amongst others. For example, the passivation layers may include dielectric materials, such as silicon dioxide (SiO₂), silicon nitride (Si₃N₄), aluminium oxide (Al₂O₃), hafnium dioxide (HfO₂), and so on. Alternatively, the passivation layers may include thin semiconductor layers or thin metal layers, including tungsten (W), cobalt (Co), palladium (Pd), aluminium (Al), silver (Ag), platinum (Pt), and so on. The passivation layers may also include chemical modification layers where functional groups may be introduced to the surfaces of the semiconductor materials or metallic materials in favour of the better performances of the devices (sensors) described herein.

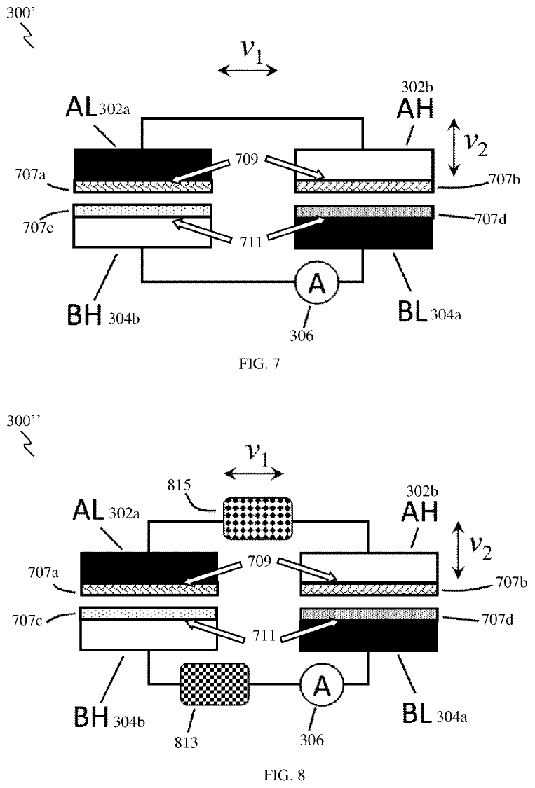

FIG. 7 shows a schematic view of the sensor 300′where all four electrodes 302a, 302b, 304a, 304b (described in similar context with the first electrode 102a, the second electrode 102b, the third electrode 104a, and the fourth electrode 104b of FIG. 1A, respectively) are coated with passivation layers 707a, 707b, 707d, 707c, according to one example. The front surfaces 709 of the two electrodes, AL 302a and AH 302b, of the primary pair may be respectively coated with passivation layers 707a, 707b, in order to reduce the surface states and prevent the front surfaces from oxidation and/or contamination. Passivation layers 707a, 707b may (or may not) be the same kind of the material. The front surfaces 711 (which may be referred to frontal surfaces) of the two electrodes, BL 304a and BH 304b, of the secondary pair may be respectively coated with passivation layers 707d, 707c, in order to reduce the surface states and prevent the frontal surfaces from oxidation and/or contamination. Passivation layers 707d, 707c may (or may not) be the same kind of the material. At least one of Electrode AL 302a or Electrode AH 302b may move relative to at least one of Electrode BH 304b or Electrode BL 304a in one or both directions v₁, v₂. Relative motion in direction v₁ may provide lateral offset between the primary pair and the secondary pair, while relative motion in direction v₂ may provide variation in the gap width (e.g. denoted as d₁, d₂ in FIGS. 3 to 6).

In various embodiments, the sensor 100 may further include a built-in potential difference multiplier (BPDM) electrically coupled to the third electrode 104a and the fourth electrode 104b of the secondary sensing part 104. The one or more electrical signals generated may be enhanced by the BPDM.

In other embodiments, the sensor 100 may further include a (or another) built-in potential difference multiplier (BPDM) electrically coupled to the first electrode 102a and the second electrode 102b of the primary sensing part 102. The one or more electrical signals generated between the third electrode 104a and the fourth electrode 104b of the secondary sensing part 104 may be enhanced by the BPDM electrically coupled to the first electrode 102a and the second electrode 102b of the primary sensing part 102.

FIG. 8 shows a schematic view of the sensor 300″ that is based on the sensor 300′of FIG. 7 where all four electrodes 302a, 302b, 304a, 304b (described in similar context with the first electrode 102a, the second electrode 102b, the third electrode 104a, and the fourth electrode 104b of FIG. 1A, respectively) are coated with passivation layers 707a, 707b, 707d, 707c, according to one example. As seen in the general structure of the sensor 300″ of FIG. 8, the sensor 300″ includes a primary pair of electrodes, i.e. AL 302a and AH 302b and a secondary pair of electrodes, i.e. BL 304a and BH 304b. BPDM 815 and BPDM 813 are respectively introduced to the primary pair of electrodes 302a, 302b and the secondary pair of electrodes 304a, 304b. The generated electrical signal in between the secondary pair of electrodes 304a, 304b may be enhanced if BPDM 815 is introduced to the primary pair of electrodes 302a, 302b and/or BPDM 813 is introduced to the secondary pair of electrodes 304a, 304b.

In other examples (not shown in FIG. 8), only BPDM 815 may be introduced to the primary pair of electrodes 302a, 302b or only BPDM 813 may be introduced to the secondary pair of electrodes 304a, 304b.

The introduction of BPDMs may further boost the induced electrical signal magnitude of the generated electrical signal, as measured by the electrical measurement unit 306 that is introduced to the secondary pair of electrodes 304a, 304b.

In various embodiments, the built-in potential difference multiplier, BPDM, may include one of the following:
one or more components coupled in series, each component including a first portion including a metal or a semiconductor, or a ferroelectric material, or a pyroelectric material, or a functionalized material and a second portion including another metal or another semiconductor, or another ferroelectric material, or another pyroelectric material, or another functionalized material, wherein the second portion is adjacent to the first portion;
one or more diodes coupled in series; or
one or more energy storage devices coupled in series.

Each of these options will be discussed below.

In the context of the BPDM being one or more components, an insulating spacer may be arranged between each component of the one or more components and a neighbouring component of the one or more components. In other words, each component is seperated from its neighbouring component(s) with the insulating spacer(s). For example, the insulating spacer may include an air gap or an insulating material. Insulating spacers (or simply referred herein as spacers) may be introduced to separate the couples (or interchangeably referred to as component) in the BPDM(s). The spacers may be simply air gaps or insulating materials, such as polymers, porous organosilicate glass, amongst others.

For or in each component, an interlayer may be arranged between the first portion and the second portion to enhance the electrical signals. The interlayer(s) may also be introduced in between the first portion and the second portion through physical or chemical processes. Thus, the interlayers may be metals or semiconductors, semimetals, conductive materials, ferroelectric materials, pyroelectric materials, functionalized materials, amongst others.

In other words, the BPDM may contain one component (or interchangeably referred to as couple) or multiple couples of materials. For example, the two materials in each couple may intimately contact each other or be bonded together through an interlayer. The two materials are in effect electrically connected. In between the couples, or more specifically, two adjacent couples, an insulating spacer may be introduced. All the couples may be electrically connected in series through a metal wire or electric connection. For example, the metal or semiconductor or ferroelectric material or pyroelectric material or functionalized material of the first portion has a work function, and the other metal or semiconductor or ferroelectric material or pyroelectric material or functionalized material of the second portion has another work function different from the work function of the metal or semiconductor or ferroelectric material or pyroelectric material or functionalized material of the first portion.

In a more specific context of the BPDM electrically coupled to the first electrode 102a and the second electrode 102b of the primary sensing part 102, the higher work function material (e.g. the first portion) in the first couple may be electrically connected to the higher work function electrode (e.g. the second electrode 102b) of the primary pair (e.g. the primary sensing part 102) through a metal wire or electric connection. The lower work function material (e.g. the second portion) in the last couple may be electrically connected to the lower work function electrode (e.g. the first electrode 102a) of the primary pair through a metal wire or electric connection. The materials used in the BPDM may or may not be the same as the materials of the electrodes 102a, 102b of the primary pair (e.g. the primary sensing part 102).

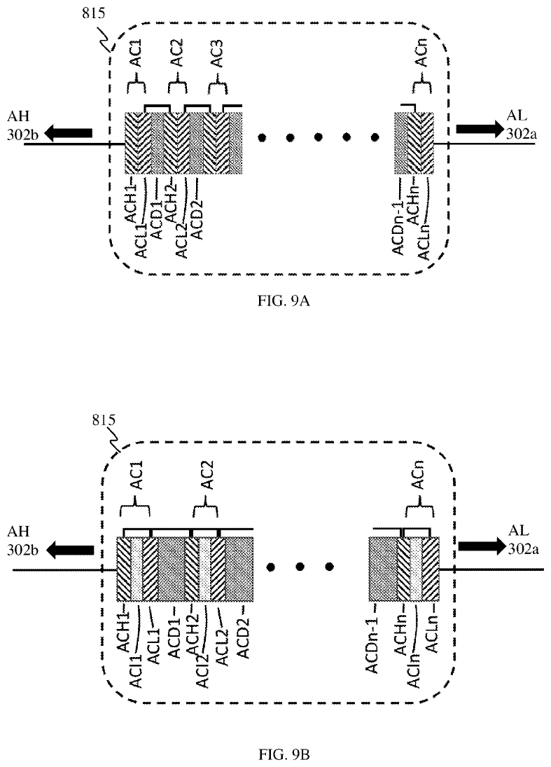

For better exemplary illustration, FIG. 9A shows an expanded schematic view of the BPDM 815 introduced to the primary pair of electrodes 302a, 302b, in the form of more components (or multiple couples) coupled in series with insulating spacers, according to one example, and FIG. 9B shows an expanded schematic view of the BPDM 815 of FIG. 9A, additionally with conductive interlayers included, according to one example. The primary pair of electrodes 302a, 302b may be described in similar context to the first electrode 102a and the second electrode 102b of the primary sensing part 102.

In FIG. 9A, the BPDM 815 may contain multiple couples (AC1, AC2, AC3, ..., ACn) of lower (ACL1, ACL2, ..., ACLn) and higher (ACH1, ACH2, ..., ACHn) work function metals or semiconductors. The two materials (e.g. ACH1, ACL1) in each couple (e.g. AC1) may intimately contacted each other. In between two adjacent couples, a spacer (ACD1, ACD2, ..., ACDn-1) may be introduced. For example, the spacer ACD1 may be arranged adjacent to and between the lower work function material ACL1 and the higher work function material ACH2 of the neighbouring couple AC2, while the spacer ACD2 may be arranged adjacent to and between the lower work function material ACL2 of AC2 and the higher work function material of the subsequent couple AC3, and so on. All the materials may be electrically connected in series through a metal wire or electric connection. When multiple couples (AC1, AC2, AC3, ..., ACn) are used, the higher work function material (ACH1) in the first couple is electrically connected to the higher work function material (electrode) of the primary pair (AH 302b) through a metal wire or electric connection, and the lower work function material (ACLn) in the last couple is electrically connected to the lower work function material (electrode) of the primary pair (AL 302a) through a metal wire or electric connection. Not shown in FIG. 9A, when only one couple (AC1) is used, the higher work function material (ACH1) in this couple is electrically connected to the higher work function material (electrode) of the primary pair (AH 302b) through a metal wire or electric connection, and the lower work function material (ACL1) in this couple is electrically connected to the lower work function material (electrode) of the primary pair (AL 302a) through a metal wire or electric connection.

In FIG. 9B, the BPDM 815 may further include an interlayer (ACI1, ACI2, ..., ACIn) disposed between the two materials in each couple (i.e. between the first portion and the second portion of each component). For example, the interlayer ACI1 is disposed between the higher work function material (ACH1) and the lower work function material (ACL1).

In the context of the BPDM being one or more diodes, each of the one or more diodes may include a p-n semiconductor junction diode, or a p-i-n semiconductor junction diode, or a Schottky junction diode, or others.

In a more specific context of the BPDM electrically coupled to the first electrode 102a and the second electrode 102b of the primary sensing part 102, the one or more diodes may be connected in series so that the anode of the first diode may be connected to the higher work function electrode (e.g. the second electrode AH 102b) of the primary pair (e.g. the primary sensing part 102), the cathode of the first diode is connected to the anode of the second diode and so on. The cathode of the last diode is connected to the lower work function material electrode (e.g. the first electrode AL 102a) of the primary pair.

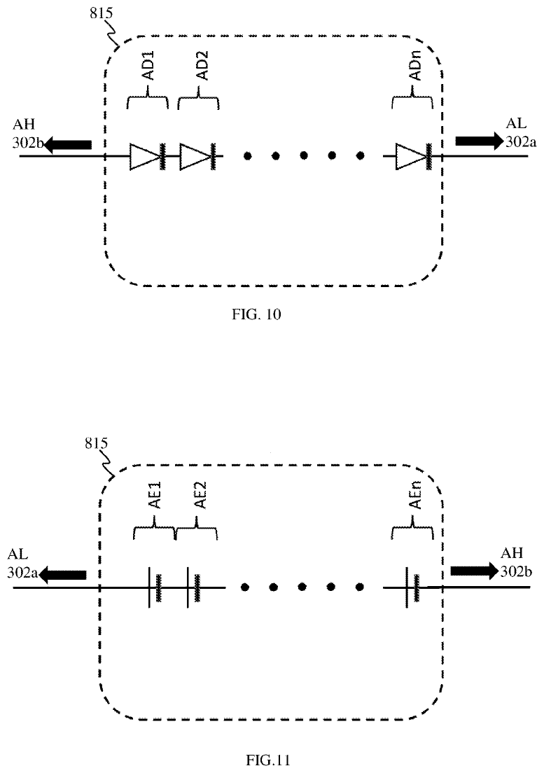

For better exemplary illustration, FIG. 10 shows an expanded schematic view of the BPDM 815 introduced to the primary pair of electrodes 302a, 302b, in the form of multiple diodes (AD1, AD2, ..., ADn) coupled in series, according to one example. The primary pair of electrodes 302a, 302b may be described in similar context to the first electrode 102a and the second electrode 102b of the primary sensing part 102.

In FIG. 10, the diodes (AD1, AD2, ..., ADn) are connected in series so that the anode of the first diode (AD1) is connected to the higher work function material (electrode) of the primary pair (AH 302b) and the cathode of the last diode (ADn) is connected to the lower work function material (electrode) of the primary pair (AL 302a).

In the context of the BPDM being one or more energy storage devices, each of the one or more energy storage devices may include a battery, a rechargeable battery, a capacitor, a capacitive device, or a voltage source, or others.

For better exemplary illustration, FIG. 11 shows an expanded schematic view of the BPDM 815 introduced to the primary pair of electrodes 302a, 302b, in the form of multiple batteries or capacitors (AE1, AE2, ..., AEn) coupled in series, according to one example. All batteries (or capacitors) (AE1, AE2, ..., AEn) involved are connected in series. The positive terminal of the first battery or capacitor (AE1) is electrically connected to the lower work function material (Electrode AL 302a) of the primary pair through a metal wire or electric connection. The negative terminal of the last battery or capacitor (AEn) is electrically connected to the higher work function material (Electrode AH 302b) of the primary pair through a metal wire or electric connection. The batteries or capacitors, may be rechargeable with the electric current rectified from the generated current flowing between the primary pair of electrodes 302a, 302b.

The different options of BPDMs may also be applicable to the BPDM electrically coupled to the fourth electrode 104b and the third electrode 104a of the secondary sensing part 104 via the one or more electrical measurement units 106, as explained further below.

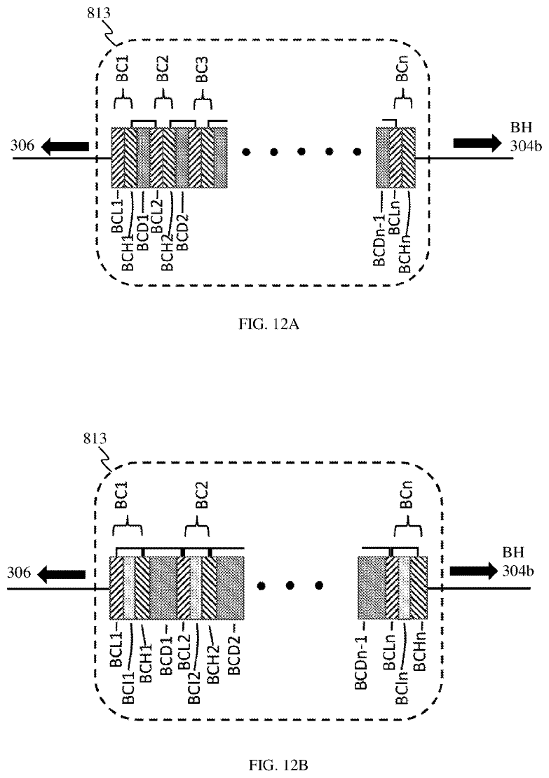

FIG. 12A shows an expanded schematic view of the BPDM 813 introduced to the secondary pair of electrodes 304a, 304b via the electrical measurement unit 306, in the form of more components (or multiple couples) coupled in series with insulating spacers, according to one example, and FIG. 12B shows an expanded schematic view of the BPDM 813 of FIG. 12A, additionally with conductive interlayers included, according to one example. The secondary pair of electrodes 304a, 304b may be described in similar context to the third electrode 104a and the fourth electrode 104b of the secondary sensing part 104.

The BPDM 813 may include one couple (BC1) or multiple couples (BC1, BC2, BC3, ..., BCn) of lower (BCL1, BCL2, ..., BCLn) and higher (BCH1, BCH2, ..., BCHn) work function metals or semiconductors. The two materials in each couple may intimately contact each other, as shown in FIG. 12A, or bonded together through an interlayer (BCI1, BCI2, ..., BCIn), as shown in FIG. 12B. In between two adjacent couples, a spacer (BCD1, BCD2, ..., BCDn) may be introduced. All the lower and higher work function materials are electrically connected in series through a metal wire or electric connection. When multiple couples (BC1, BC2, BC3, ..., BCn) are used, the lower work function material (BCL1) in the first couple is electrically connected to the electrical measurement unit 306 and then to the lower work function material (electrode) of the secondary pair (BL 304a) not shown in FIGS. 12A and 12B, through a metal wire or electric connection. The higher work function material (BCHn) in the last couple is electrically connected to the higher work function material (electrode) of the secondary pair (BH 304b). The materials used in the BPDM 813 may or may not be the same as the materials (electrodes) of the secondary pair (BH 304b, BL 304a), which may be described in similar context to the materials of the electrodes 104b, 104a of the secondary pair (e.g. the secondary sensing part 104). The materials used in the BPDM 813 may or may not also be the same as the corresponding materials used in the BPDM 815 electrically coupled to the primary pair.

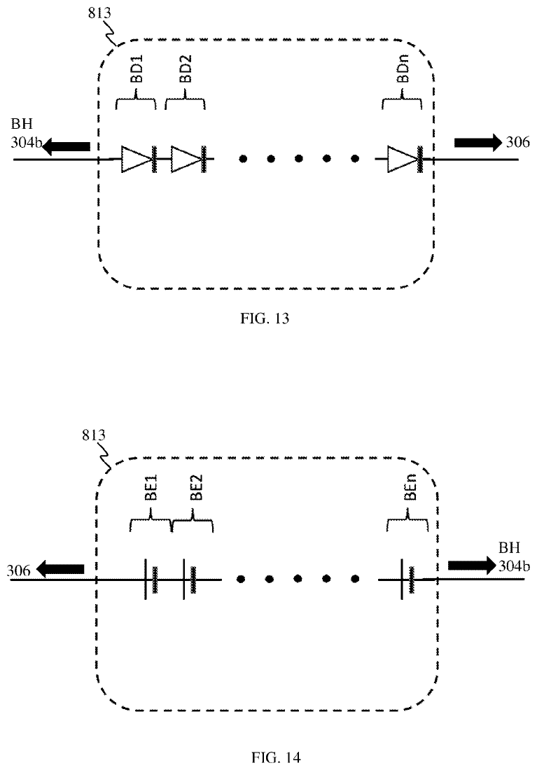

FIG. 13 shows an expanded schematic view of the BPDM 813 introduced to the secondary pair of electrodes 304a, 304b via the electrical measurement unit 306, in the form of multiple diodes (BD1, BD2, ..., BDn) coupled in series, according to one example. The secondary pair of electrodes 304a, 304b may be described in similar context to the third electrode 104a and the fourth electrode 104b of the secondary sensing part 104.

The BPDM 813 may include one (BD1) or multiple diodes (BD1, BD2, ..., BDn). The diode(s) may be be p-n or p-i-n semiconductor junction diodes, Schottky junction diodes, or others. As seen in FIG. 13, the diodes (BD1, BD2, ..., BDn) is connected in series so that the anode of the first diode (BD1) may be connected to the higher work function material (electrode) of the secondary pair (BH 304b), the cathode of the first diode (BD1) is connected to the anode of the second diode (BD2) and so on. The cathode of the last diode (BDn) is connected to the electrical measurement unit 306, and then to the lower work function material (electrode) of the secondary pair (BL 304a), not shown in FIG. 13.

FIG. 14 shows an expanded schematic view of the BPDM 813 introduced to the secondary pair of electrodes 304a, 304b via the electrical measurement unit 306, in the form of multiple batteries or capacitors (BE1, BE2, ..., BEn) coupled in series, according to one example.

The BPDM 813 may include one battery or capacitor (BE1) or multiple batteries or capacitors (BE1, BE2, ..., BEn). All batteries (or capacitors) involved are connected in series. As seen in FIG. 14, the positive terminal of the first battery or capacitor (BE1) is electrically connected to the electrical measurement unit 306 and then to lower work function material (Electrode BL 304a) of the secondary pair (not shown in FIG. 14) through a metal wire or electric connection. The negative terminal of the last battery or capacitor (BEn) is electrically connected to the higher work function material (Electrode BH 304b) of the secondary pair through a metal wire or electric connection.

The different options of BPDMs may be used in the various configurations and adaptions of the sensor 100 of FIG. 1A.

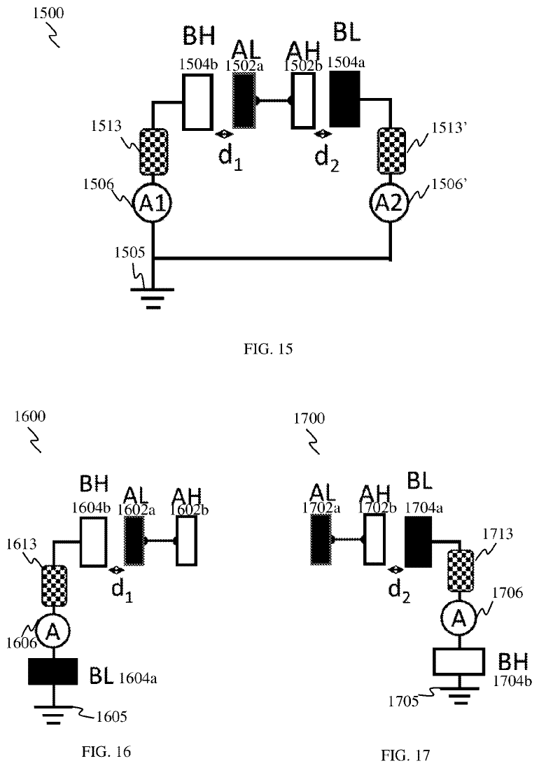

For example, FIG. 15 shows a schematic view of a structure of the sensor 1500 adapted from the sensor 400 of FIG. 4 with BPDMs included. The sensor 1500 may include the same or like elements or components as those of the sensor 100 of FIG. 1A or the sensor 300, 400 of FIGS. 3 and 4, and as such, the same ending numerals are assigned and the like elements may be as described in the context of the sensor 100 of FIG. 1A or the sensor 300, 400 of FIG. 4, and therefore the corresponding descriptions may be omitted here. In FIG. 15, Electrode BH 1504b of the secondary pair is connected to a BPDM 1513, an electrical measurement unit A1 1506 and then to the ground 1505. Electrode BL 1504a of the secondary pair is connected to another BPDM 1513′, another electrical measurement unit A2 1506′ and then to the ground 1505. Electrode BH 1504b of the secondary pair is facing towards or to Electrode AL 1502a of the primary pair, while Electrode BL 1504a of the secondary pair is facing towards or to Electrode AH 1502b of the primary pair. The distance between Electrode AH 1502b and Electrode AL 1502a in the primary pair may or may not be fixed. The distance between Electrode BH 1504b and Electrode BL 1504a in the secondary pair may or may not be fixed. The two electrodes of the primary pair of electrodes 1502a, 1502b are configured to collectively move relatively to the two electrodes 1504a, 1504b in the secondary pair of electrodes. This configuration may allow the electrical measurement unit A1 1506 and the other electrical measurement unit A2 1506′ to measure the electrical signals associated with the variation of gap width d₁ (due to relative motion between Electrode BH 1504b and Electrode AL 1502a) and the variation of gap width d₂ (due to relative motion between Electrode AH 1502b and Electrode BL 1504a), respectively.

In another example, FIG. 16 shows a schematic view of a structure of the sensor 1600 adapted or reconfigured from the sensor 500, 1500 of FIGS. 5 and 15, according to one example. The sensor 1600 may include the same or like elements or components as those of the sensor 100 of FIG. 1A or the sensor 500, 1500 of FIGS. 5 and 15, and as such, the same ending numerals are assigned and the like elements may be as described in the context of the sensor 100 of FIG. 1A or the sensor 500, 1500 of FIGS. 5 and 15, and therefore the corresponding descriptions may be omitted here. In FIG. 16, Electrode BH 1604b of the secondary pair, being the higher work function electrode, is facing towards Electrode AL 1602a of the primary pair, while Electrode BL 1604a of the secondary pair, being the lower work function electrode, is grounded, i.e. connected to the ground 1605. A BPDM 1613 connected in series with an electrical measurement unit 1606 are introduced in between the two electrodes of the secondary pair 1604a, 1604b. Electrode AH 1602b may be not arranged to face to any electrodes 1604a, 1604b in the secondary pair. The distance between Electrode AH 1602b and Electrode AL 1602a in the primary pair may or may not be fixed. The two electrodes of the primary pair of electrodes 1602a, 1602b are configured to collectively move relative to Electrode BH 1604b in the secondary pair of electrodes.

In yet another example, FIG. 17 shows a schematic view of a structure of the sensor 1700 adapted or reconfigured from the sensor 600, 1500 of FIGS. 6 and 15, according to one example. The sensor 1700 may include the same or like elements or components as those of the sensor 100 of FIG. 1A or the sensor 600, 1500 of FIGS. 6 and 15, and as such, the same ending numerals are assigned and the like elements may be as described in the context of the sensor 100 of FIG. 1A or the sensor 600, 1500 of FIGS. 6 and 15, and therefore the corresponding descriptions may be omitted here. In FIG. 17, Electrode BL 1704a of the secondary pair, being the lower work function electrode, is facing towards Electrode AH 1702b of the primary pair, while Electrode BH 1704b of the secondary pair is grounded, i.e. connected to the ground 1705. A BPDM 1713 connected in series with an electrical measurement unit 1706 is introduced in between the two electrodes of the secondary pair 1704a, 1704b. Electrode AL 1702a may be not arranged to face to any electrodes 1704a, 1704b in the secondary pair. The distance between Electrode AH 1702b and Electrode AL 1702a in the primary pair may or may not be fixed. The two electrodes of the primary pair of electrodes 1702a, 1702b are configured to collectively move relative to Electrode BL 1704a in the secondary pair of electrodes.

FIG. 1B shows a flow chart illustrating a method 120 for determining at least one quantifiable parameter of relative motion between a movable object (e.g. 108 in FIG. 1A) and a stationary object or another movable object (e.g. 110 in FIG. 1A), according to various embodiments. As seen in FIG. 1B, a sensor (e.g. 100) may be provided at Step 122. The sensor may include a primary sensing part (e.g. 102) including a first electrode (e.g. 102a) and a second electrode (e.g. 102b) electrically coupled to the first electrode; a secondary sensing part (e.g. 104) including a third electrode (e.g. 104a) and a fourth electrode (e.g. 104b) electrically coupled to the third electrode; and one or more electrical measurement units (e.g. 106) each electrically coupled to: the third electrode, or the fourth electrode, or both the third electrode and the fourth electrode, or the first electrode, or the second electrode, or both the first electrode and the second electrode. The first electrode may include a first material and the second electrode may include a second material. The third electrode may include a third material, and the fourth electrode may include a fourth material. The first material, the second material, the third material and the fourth material may be either different from one another or the same. The primary sensing part and the secondary sensing part may be free from electrical connection with each other. At Step 124, at least one portion of the primary sensing part may be attached to the movable object. At Step 126, at least one portion of the secondary sensing part may be attached to the stationary object or the other movable object with the third electrode positioned facing towards the second electrode of the primary sensing part and/or with the fourth electrode positioned facing towards the first electrode of the primary sensing part. At Step 128, one or more electrical signals generated in or through the sensor may be measured by the one or more electrical measurement units. The generated one or more electrical signals may be representative of the at least one quantifiable parameter of relative motion between the primary sensing part and the secondary sensing part.

In other words, methods for detecting relative motions between a movable object and a stationary object or another movable object using the sensor may be provided. The electrodes of the primary pair may be attached to a movable object, while the electrodes of the secondary pair may be fixed to a stationary object or another movable object. There is no wire connection or electric connection between the primary pair of electrodes and the secondary pair of electrodes. When the electrodes of the primary pair have or experience a motion with respect to the electrodes of the secondary pair in a range where electrostatic induction between them plays a role, electrical signals are generated within each electrode pair. The generated electrical signal(s) in the secondary pair may be detected by the one or more electrical measurement units and may provide the information of the relative motion of the movable object with respect to the stationary object or the other movable object, including, but not limited to the relative motion speed, vibration amplitude and frequency, the transient gap width between them, rotor eccentricity, and so on. The generated or induced electrical signals are converted from the mechanical power of the movable object through electrostatic induction without using external power. Thus, this sensor may be self-powered through mechanical to electric power conversion. In this sense, with appropriate minor adjustments of the device architectures, the sensor may be used to harvest the mechanical power of the movable object. Alternatively, the sensor may be externally powered.

The sensor may include the sensor 100 (FIG. 1A), or the sensor 300 (FIGS. 3), 400 (FIGS. 4), 500 (FIGS. 5), 600 (FIGS. 6), 300′ (FIGS. 7), 300″ (FIGS. 8), 1500 (FIGS. 15), 1600 (FIGS. 16), 1700 (FIG. 17), according to various embodiments and examples.

In different embodiments, the at least one portion of the primary sensing part may refer to only the first electrode, or only the second electrode, or both the first electrode and the second electrode, or all parts/elements of the primary sensing part. The at least one portion of the secondary sensing part may refer to only the third electrode, or only the fourth electrode, or both the third electrode and the fourth electrode, or all parts/elements of the secondary sensing part.

Attaching at least one portion of the primary sensing part to the movable object at Step 124 may cause the first electrode and the second electrode of the primary sensing part to be positioned at a pre-determined distance apart from each other. The pre-determined distance may be fixed or remain unchanged or may not be fixed when the sensor is in use. Attaching at least one portion of the secondary sensing part to the stationary object or the other movable object at Step 126 may cause the third electrode and the fourth electrode of the secondary sensing part to be positioned at a pre-defined distance apart from each other. The pre-defined distance may remain unchanged or may not be fixed when the sensor is in use. In effect, the first electrode and the second electrode of the primary sensing part may be configured to collectively move relatively to the third electrode, or the fourth electrode, or both the third electrode and the fourth electrode of the secondary sensing part.

In some embodiments, attaching the at least one portion of the primary sensing part to the movable object at Step 124 may include attaching the primary sensing part to the movable object with the first electrode positioned facing towards the fourth electrode of the secondary sensing part or the second electrode positioned facing towards the third electrode of the secondary sensing part or both. In these embodiments, measuring the one or more currents at Step 128 may include measuring the one or more electrical signals representative of at least one of a relative motion speed or a gap width of the movable object with respect to the stationary object or the other movable object.

FIG. 18 shows a schematic view illustrating an exemplary arrangement 1817 where a sensor 1800 is used to monitor the linear motion speed of a movable object 1808 with respect to the stationary object or another movable object 1810 and the gap width between them. The sensor 1800 may include the same or like elements or components as those of the sensor 100 of FIG. 1A, and as such, the same ending numerals are assigned and the like elements may be as described in the context of the sensor 100 of FIG. 1A, and therefore the corresponding descriptions may be omitted here. In the exemplary arrangement 1817, the electrodes of the primary pair (AL 1802a and AH 1802b), together with a BPDM 1815, may be attached to or hosted on a movable object 1808. The electrodes of the secondary pair (BL 1804a and BH 1804b), together with another BPDM 1813 and an electrical measurement unit 1806, may be fixed to a stationary object or another movable object 1810. Once the electrodes of the primary pair (AL 1802a and AH 1802b) and of the secondary pair (BL 1804a and BH 1804b) are attached or fixed, the distance between Electrode AH 1802b and Electrode AL 1802a in the primary pair may or may not be fixed, and the distance between Electrode BH 1804b and Electrode BL 1804a in the secondary pair may or may not be fixed as well. The two electrodes of the primary pair of electrodes 1802a, 1802b are configured to collectively move relative to the two electrodes 1804a, 1804b in the secondary pair of electrodes. An electrical signal is generated in between the electrodes of the secondary pair (BL 1804a and BH 1804b) if the electrodes of the primary pair (AL 1802a and AH 1802b) move with respect to the electrodes of the secondary pair (BL 1804a and BH 1804b) in parallel to the electrode surfaces (the v₁ direction in FIG. 18) or perpendicular to the electrode surfaces (the v₂ direction in FIG. 18). The generated electrical signal in the secondary pair (BL 1804a and BH 1804b) may provide the information of the motion speed of the movable object 1808 with respect to the stationary object or another movable object 1810 and the gap width between them.

In other embodiments, the movable part may include a rotor of a motor, the stationary part may include a stator of the motor, and measuring the one or more electrical signals at Step 128 may include measuring the one or more electrical signals representative of at least one of a rotational speed or an eccentricity of the rotor.

FIG. 19 shows a schematic view illustrating an exemplary arrangement 1917 where a sensor 1900 is used to monitor the eccentricity in the horizontal direction 1921 and the rotation speed 1919 of a rotor 1908. The sensor 1900 may include the same or like elements or components as those of the sensor 100 of FIG. 1A, and as such, the same ending numerals are assigned and the like elements may be as described in the context of the sensor 100 of FIG. 1A, and therefore the corresponding descriptions may be omitted here. In the exemplary arrangement 1917, the electrodes of the primary pair (AL 1902a and AH 1902b), together with a BPDM 1915, may be attached to a rotor 1908. The rotor 1908 may be either an insulator or a conductor. The electrodes of the secondary pair (BL 1904a and BH 1904b), together with another BPDM 1913 and an electrical measurement unit 1906, may be fixed to a stator 1910. Once the electrodes of the primary pair (AL 1902a and AH 1902b) and of the secondary pair (BL 1904a and BH 1904b) are attached or fixed, the distance between Electrode AH 1902b and Electrode AL 1902a in the primary pair may or may not be fixed, and the distance between Electrode BH 1904b and Electrode BL 1904a in the secondary pair may or may not be fixed as well. The two electrodes of the primary pair of electrodes 1902a, 1902b are configured to collectively move relatively in an angular manner to the two electrodes 1904a, 1904b in the secondary pair of electrodes. The generated electrical signal in the secondary pair (BL 1904a and BH 1904b) may be measured by the electrical measurement unit 1906 and may provide the information of the eccentricity (as denoted by bi-directional arrow 1921) and the rotation speed 1919 of the rotor 1908.

In various embodiments, the method 120 of FIG. 1B may further include providing another secondary sensing part including a fifth electrode and a sixth electrode electrically coupled to the fifth electrode; providing another electrical measurement unit electrically coupled to at least one of the fifth electrode or the sixth electrode; and measuring, by the other electrical measurement unit, another electrical signal generated in or through the sensor. The fifth electrode may include a fifth material and the sixth electrode may include a sixth material. The other secondary sensing part may be attached to the stator with at least one of the fifth electrode or the sixth electrode arranged angularly spaced apart from the third electrode and the fourth electrode of the secondary sensing part. The one or more electrical signals measured by the one or more electrical measurement units and the other electrical signal measured by the other electrical measurement unit may be used to determine the eccentricity of the rotor in two different directions. The fifth material may be different from or may be the same as the sixth meterial. Each of the fifth material and the sixth material may be the same as or may be different from the materials used in the first, or second or thrid or fourth electrode. Each of the fifth electrode and six electrode may include more than one material. Each of the fifth material and the sixth material may include a metal, or a semiconductor, or a ferroelectric material, or a pyroelectric material or others. For example, the fifth material may have a fifth work function and the sixth material may have a sixth work function different from the fifth work function. The fifth work function may be less than 4.3 eV, and the sixth work function may be more than 4.5 eV. The fifth material may be a metal or an n-type semiconductor, and may include aluminium, titanium, silver, or lead or n-type semiconductors. The sixth material may be another metal or another semiconductor, and may include gold, platinum, or nickel or p-type semiconductors. In some examples, the fifth material may be the same as the third material of the third electrode of the secondary sensing part, and/or the sixth material may be the same as the fourth material of the fourth electrode of the secondary sensing part. In other examples, the fifth material may be different from the third material, and/or the sixth material may be different from the fourth material.

In various embodiments, the method 120 may include providing one or more other secondary sensing parts; each of the one or more other secondary sensing parts including two electrodes electrically coupled to each other; providing one or more other electrical measurement units electrically coupled to at least one of the two electrodes in each of the one or more other secondary sensing parts; and measuring, by the one or more other electrical measurement units, one or more other electrical signals generated in each of the one or more other secondary sensing parts, wherein the one or more other secondary sensing parts are attached to the stator with each of the secondary sensing part and the one or more other secondary sensing parts arranged angularly spaced apart from one another; and wherein the one or more electrical signals measured by the one or more electrical measurement units in the secondary sensing part and the one or more other electrical signals measured by each of the one or more other secondary sensing parts are used to determine the eccentricity of the rotor in two or moredifferent directions. For example, the method 120 may further include providing 3^{rd} secondary sensing part and 4^{th} secondary sensing part and the n^{th} secondary sensing part (n is an integer larger than 4). In each of these secondary sensing parts, one or two electrical measurement units are electrically coupled to at least one of the electrodes and measuring another electrical signal generated in each of the secondary sensing pair. Each of the other secondary sensing parts may be attached to the stator with angularly spaced apart from each other. The electrical signals may be processed to determine the rotor eccentricity in the direction of that secondary sensing part.

FIG. 20A shows a schematic view illustrating an exemplary arrangement 2017 where a sensor 2000 is used to monitor the eccentricity in both horizontal direction 2021 and vertical direction 2023, as well as the rotation speed 2019 of a rotor 2008. The sensor 2000 may include the same or like elements or components as those of the sensor 100 of FIG. 1A, and as such, the same ending numerals are assigned and the like elements may be as described in the context of the sensor 100 of FIG. 1A, and therefore the corresponding descriptions may be omitted here. In the exemplary arrangement 2017, the electrodes of the primary pair (AL 2002a and AH 2002b), together with a BPDM 2015, may be attached to a rotor 2008. The rotor 2008 may be either an insulator or a conductor. Two sets of the electrodes of the secondary pairs (BL1 2004a and BH1 2004b, BL2 2004a′ and BH2 2004b′), two respective BPDMs 2013, 2013′ and the respective electrical measurement unit(s) (AH 2006a, Av 2006b) may be fixed to a stator 2010. One set of the electrodes of the secondary pair (BL1 2004a and BH1 2004b) may be placed on the stator 2010 along the horizontal direction (as denoted by bi-directional arrow 2021) and the other set of the electrodes of the secondary pair (BL2 2004a′ and BH2 2004b′) may be placed on the stator 2010 along the vertical direction direction (as denoted by bi-directional arrow 2023). Once the electrodes of the primary pair (AL 2002a and AH 2002b) and of the two sets of secondary pairs (BL1 2004a, BH1 2004b, BL2 2004a′ and BH2 2004b′) are attached or fixed, the distance between Electrode AH 2002b and Electrode AL 2002a in the primary pair may or may not be fixed, the distance between Electrode BH1 2004b and Electrode BL1 2004a in one secondary pair may or may not be fixed, and the distance between Electrode BH2 2004b′ and Electrode BL2 2004a′ in the other secondary pair may or may not be fixed as well. The two electrodes of the primary pair of electrodes 2002a, 2002b are configured to collectively move relatively in an angular manner to the two sets of secondary pairs (BL1 2004a, BH1 2004b, BL2 2004a′ and BH2 2004b′). The electrical signals generated in the two sets may be monitored by the two electrical measurement units AH 2006a, Av 2006b and may provide the information of the rotor eccentricity in the horizontal direction 2021 as well as the vertical direction 2023. In other words, the electrical signals may be processed to determine the rotor eccentricity in the horizontal direction 2021 as well as the vertical direction 2023.

In alternative embodiments of the method 120 of FIG. 1B, providing the sensor at Step 122 may include providing one or more electrodes attached to the stator with each of the electrodes arranged angularly spaced apart from each other; providing one electrical measurement unit electrically coupled to each of the electrodes through a ground; and wherein measuring the electrical signal generated in between each of the electrodes and the ground, by the electrical measurement unit, the electrical signals measured by each of the electrical measurement units being used to determine the eccentricity of the rotor in the one or more than one direction and the rotation speed.

In alternative embodiments of the method 120 of FIG. 1B, providing the sensor at Step 122 may include providing one of the one or more electrical measurement units electrically coupled to the third electrode of the secondary sensing part through a ground, while another of the one or more electrical measurement units is electrically coupled to the fourth electrode of the secondary sensing part through the ground; and arranging the third electrode angularly spaced apart from the fourth electrode at an angle of less than 180°, and measuring the one or more electrical signals generated in the sensor at Step 128 may include measuring, by the electrical measurement unit and the other electrical measurement unit, two electrical signals generated in or through the sensor. The two electrical signals, respectively measured by the electrical measurement unit and the other electrical measurement unit, may be used to determine the eccentricity of the rotor in two different directions. In other words, the method 120 may include providing one of the one or more electrical measurement units electrically coupled to the third electrode of the secondary sensing part through a ground, while another of the one or more electrical measurement units are electrically coupled to the fourth electrode of the secondary sensing part through the ground; and arranging the third electrode angularly spaced apart from the fourth electrode at an angle of less than 180°, and measuring the one or more electrical signals generated in the sensor at Step 128 may include measuring, by the electrical measurement unit and the other electrical measurement unit, two electrical signals generated in or through the sensor. The two electrical signals, respectively measured by the electrical measurement unit and the other electrical measurement unit, may be used to determine the eccentricity of the rotor in two different directions.

In alternative embodiments of the method 120 of FIG. 1B, providing the sensor at Step 122 may include more than two electrodes attached to the stator angularly spaced apart from each other. One electrical measurement unit is electrically connected to each of the electrodes and the ground. Each of the electrodes generates its own electricical signal, measured by the electrical measurement unit, that may be used to determine the eccentricity of the rotor in two different directions.

FIG. 20B shows a schematic view illustrating another or alternative exemplary arrangement 2017′ where the sensor 2000′ is used to monitor the eccentricity in both horizontal direction 2021 and vertical direction 2023, as well as the rotation speed 2019 of the rotor 2008. The sensor 2000′ may include the same or like elements or components as those of the sensor 100 of FIG. 1A, and as such, the same ending numerals are assigned and the like elements may be as described in the context of the sensor 100 of FIG. 1A, and therefore the corresponding descriptions may be omitted here. In the exemplary arrangement 2017′, the electrodes of the primary pair (AL 2002a and AH 2002b), together with the BPDM 2015, may be attached or fixed to the rotor 2008. The rotor may be either an insulator or a conductor. Electrode BH 2004b of the secondary pair may be connected to a BPDM 2013′, an electrical measurement unit (Av 2006b) and then to the ground 2005. Electrode BL 2004a of the secondary pair may be connected to another BPDM 2013, another electrical measurement unit (AH 2006a) and then to the ground 2005. Electrode BL 2004a of the secondary pair may be placed on the stator 2010 along the horizontal direction (as denoted by bi-directional arrow 2021) and Electrode BH 2004b of the secondary pair may be placed on the stator 2010 along the vertical direction (as denoted by bi-directional arrow 2023), for example above the rotor, when taking reference to FIG. 20B. In other words, Electrode BL 2004a and Electrode BH 2004b may be placed about 90° apart from each other. The electrical signals are measured by the two electrical measurement units AH 2006a, Av 2006b, and processed to have the eccentricity in the horizontal direction 2021 as well as vertical direction 2023.

It should be appreciated that while FIGS. 20A and 20B relate to relative motions in the horizontal and vertical directions, the sets of secondary pairs (in FIG. 20A) may be arranged spaced apart from each other (in pairs) at angles different from 90° or the electrodes of the secondary pair (in FIG. 20B) may be arranged spaced apart from each other (electrode-wise) at angles different from 90°, to monitor relative motions in various angular directions (not shown in FIGS. 20A and 20B). Additional set(s) of secondary pair(s) may be included, with the electrodes arranged spaced apart from one another at different angles to monitor relative motions in more than two different directions (also not shown in FIGS. 20A and 20B).

In various embodiments, the movable object may include a vibrational beam, and measuring the one or more electrical signals at Step 128 (in FIG. 1B) may include measuring the one or more electrical signals representative of at least one of a vibration amplitude or a frequency of the vibrational beam with respect to the stationary object or the other movable object.

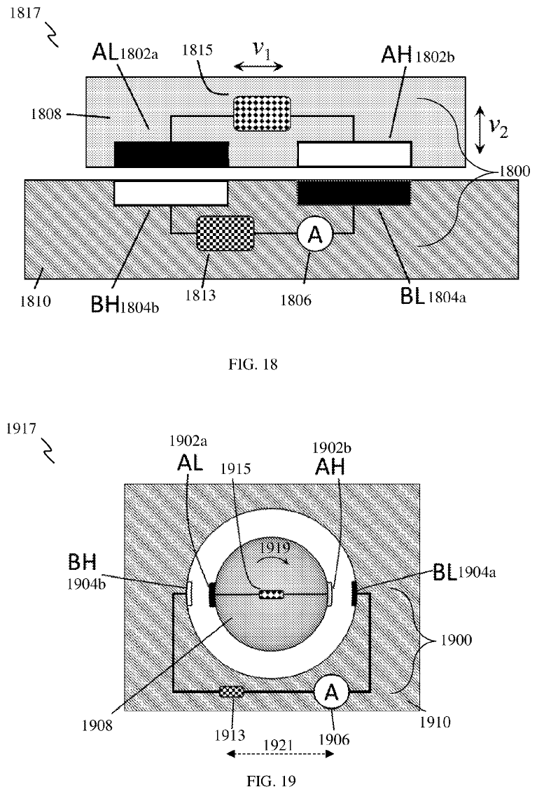

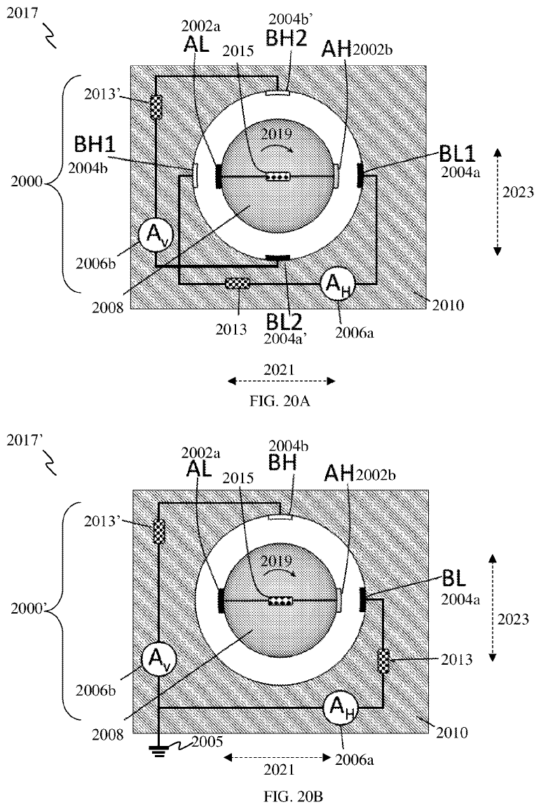

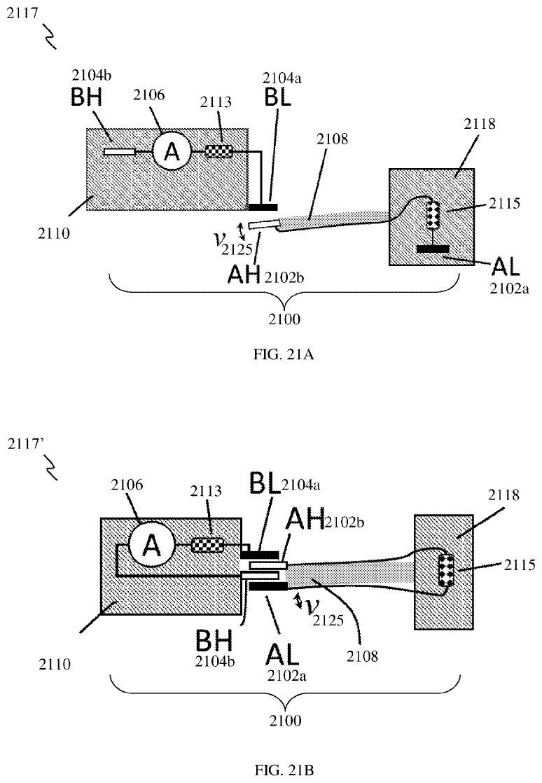

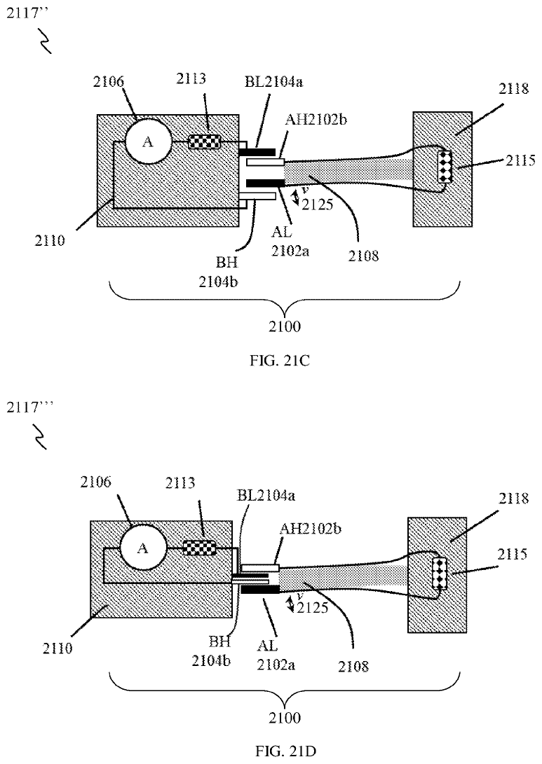

FIG. 21A shows a schematic view illustrating an exemplary arrangement 2117 where a sensor 2100 is used to monitor the vibration amplitude and frequency (v 2125) of a vibrational beam 2108 with respect to a stationary object or another movable object 2110. The sensor 2100 may include the same or like elements or components as those of the sensor 100 of FIG. 1A, and as such, the same ending numerals are assigned and the like elements may be as described in the context of the sensor 100 of FIG. 1A, and therefore the corresponding descriptions may be omitted here. In the exemplary arrangement 2117, an electrode of the primary pair (AH 2102b or AL 2102a) may be fixed to a vibrational beam 2108 and the other electrode of the primary pair (AL 2102a or AH 2102b) and a BPDM 2115 may be hosted on an adjoint stationary object 2118. In FIG. 21A, AH 2102b is fixed to the vibration beam 2108, while AL 2102a is hosted on the adjoint stationary object 2118. The opposite or vice versa arrangement of AH 2012b to the adjoint stationary object 2118, and the AL 2102a to the vibration beam 2108 (not shown) may also be considered instead. The electrodes of the secondary pair (BL 2104a and BH 2104b), together with another BPDM 2113 and an electrical measurement unit 2106, may be fixed to a stationary object or another movable object 2110. In FIG. 21A, Electrode AH 2102b is shown to be fixed to the vibrational beam 2108, and facing to Electrode BL 2104a, while Electrode AL 2102a is shown to be fixed to the adjoint stationary object 2118, and Electrode BH 2104b is not facing to any of the other electrodes 2104a, 2102a, 2102b. In the context of various examples, the stationary object or another movable object 2110 and the adjoint stationary object 2118 may be separate parts. In the context of other examples, the stationary object or another movable object 2110 and the adjoint stationary object 2118 may be integral parts of a same unit. The lower (higher) work function material (electrode) of the primary pair, AL 2102a (AH 2102b), may be facing towards the higher (lower) work function material (electrode) of the secondary pair, BH 2104b (BL 2104a). An electrical signal is generated in between the electrodes of the secondary pair (BL 2104a and BH 2104b) if the electrode of the primary pair pair (AL 2102a or AH 2102b) vibrates with respect to the electrode of the secondary pair (BH 2104b or BL 2104a). The generated electrical signal in the secondary pair may be measured by the electrical measurement unit 2106 and may provide the information of the vibration amplitude and frequency (collectively denoted by v 2125) of the vibrational beam 2108 with respect to the stationary object or another movable object 2110.

In alternative embodiments, attaching the at least one portion of the primary sensing part to the movable object at Step 124 may include attaching both the first electrode and the second electrode to the vibrational beam and including one of the following: arranging the first electrode or the second electrode between the third electrode and the fourth electrode of the secondary sensing part, while having the third electrode or the fourth electrode arranged between the first electrode and the second electrode, in a comb manner; or arranging the first electrode and the second electrode in between the third electrode and the fourth electrode of the secondary sensing part; or arranging the third electrode and the fourth electrode of the secondary sensing part in between the first electrode and the second electrode.

FIG. 21B shows a schematic view illustrating an alternative exemplary arrangement 2117′ where a sensor 2100 is used to monitor the vibration amplitude and frequency (v 2125) of a vibrational beam 2108 with respect to a stationary object or another movable object 2110. The sensor 2100 may include the same or like elements or components as those of the sensor 100 of FIG. 1A, and as such, the same ending numerals are assigned and the like elements may be as described in the context of the sensor 100 of FIG. 1A, and therefore the corresponding descriptions may be omitted here. In the exemplary arrangement 2117′, the electrodes of the primary pair (AL 2102a and AH 2102b) may be attached or fixed to the vibrational beam 2108 and the BPDM 2115 may be hosted on the adjoint stationary object 2118. The electrodes of the secondary pair (BL 2104a and BH 2104b), together with the BPDM 2113 and the electrical measurement unit 2106, may be fixed to the stationary object or another movable object 2110. One electrode of the primary pair (e.g. AH 2102b as seen in FIG. 21B) may be placed in between the two electrodes of the secondary pair BL 2104a, BH 2104b and one electrode of the secondary pair (e.g. BH 2104b as seen in FIG. 21B) may be placed in between the two electrodes of the primary pair AL 2102a, AH 2102b, in a comb manner. It should be appreciated that alternatively, AL 2102a may be placed in between the two electrodes of the secondary pair BL 2104a, BH 2104b, and BL 2104a may be placed in between the two electrodes of the primary pair AL 2102a, AH 2102b instead (not shown in FIG. 21B). In other alternative arrangements shown in FIG. 21C (FIG. 21D), the two electrodes of the primary (secondary) pair may be placed in between the two electrodes of the secondary (primary) pair. For example, both AL 2102a and AH 2102b may be placed in between both BH 2104b and BL 2104a in a sandwiched manner (FIG. 21C), or vice versa where both BH 2104b and BL 2104a may be placed in between both AL 2102a and AH 2102b in a sandwiched manner (FIG. 21D). An electrical signal is generated in between the electrodes of the secondary pair (BL 2104a and BH 2104b) if the electrode of the primary pair (AL 2102a or AH 2102b) vibrates with respect to the electrode of the secondary pair (BH 2104b or BL 2104a). The generated electrical signal in the secondary pair may be measured by the electrical measurement unit 2106 and it may provide the information of the vibration amplitude and frequency (collectively denoted by v 2125) of the vibrational beam 2108 with respect to the stationary object or another movable object 2110.

In other examples (not shown in the figures), the electrical measurement unit 2106 may be coupled to the first and second electrodes in the primary pair through the BPDM 2115 and hosted in the adjoint stationary object 2118 instead, rather than in the secondary sensing pair as seen in FIGS. 21A to 21D. An electrical signal may be generated in between the electrodes of the primary pair (AL 2102a and AH 2102b) if the electrode of the primary pair pair (AL 2102a or AH 2102b) vibrates with respect to the electrode of the secondary pair (BH 2104b or BL 2104a). The generated electrical signal in the primary pair may be measured by the electrical measurement unit 2106 hosted in the adjoint stationary object 2118 and may provide the information of the vibration amplitude and frequency (collectively denoted by v 2125) of the vibrational beam 2108 with respect to the stationary part object or another movable object 2110.

While the method described above is illustrated and described as a series of steps or events, it will be appreciated that any ordering of such steps or events are not to be interpreted in a limiting sense. For example, some steps may occur in different orders and/or concurrently with other steps or events apart from those illustrated and/or described herein. In addition, not all illustrated steps may be required to implement one or more aspects or embodiments described herein. Also, one or more of the steps depicted herein may be carried out in one or more separate acts and/or phases.

It should also be appreciated and understood that exemplary arrangements described herein are not exhaustive, and other arrangements and configurations may also be possible.

On-site sensing of relative motions between two objects, including, but not limited to detection of relative motion speed, vibration amplitude and frequency, the transient gap width between them, rotor eccentricity, and so on may be generally solved or circumvented. Several advances over the state-of-the-art are made by the sensing systems (e.g. the sensor 100 of FIG. 1A) and methods (e.g. the method 120 of FIG. 1B) provided by various embodiments desribed herein. First, detection of relative motions between two objects, including, but not limited to detection of relative motion speed, vibration amplitude and frequency, the transient gap width between them, rotor eccentricity, amongst on-site in real-time. Second, the sensing system and method may produce electrostatic induction currents or voltages (electrical signals) by the work function difference between the electrode materials involved. Hence, the sensor may be without using external power. Third, there is no wire connection or electric connection between the primary sensing part (movable object) and the secondary sensing part (stationary object or another movable object). Fourth, the sensor system and method making use of metals and/or semiconductor materials may be easily integrated into integrated circuit (IC) chips and other semiconductor devices. Fifthly, the sensor may be employed as an energy harvester to convert the mechanical power of the movable object into electric power.

Various experimental findings of the sensor and method will be described below.

### Experimental Findings

In the following experiments, aluminium with the work function of 4.28 eV is used as the lower work function electrodes. Stainless steel with the work function of 4.4 eV and gold with the work function of 4.8 eV are selected as the higher work function electrodes. The electrodes in solid black fill in FIGS. 22 to 33 are aluminium plates (lower work function materials) and the electrodes in solid white fill in FIGS. 22 to 33 are stainless steel plates or coated gold layers (higher work function materials). In all these figures under the Experimental Findings section, where applicable, AL electrode, AH electrode, BL electrode, and BH electrode may be described in similar context to the first electrode 102a, the second electrode 102b, the third electrode 104a, and the fourth electrode 104b of FIG. 1A, respectively. BL electrode and/or BH electrode are coupled to an electrical measurement unit which may be described in similar context to the electrical measurement unit 106 of FIG. 1A. The sensors used for the experiments may include the same or like elements or components as those of the sensor 100 of FIG. 1A, and as such, the same ending numerals are assigned and the corresponding descriptions may be omitted here.

### Part I. Detections of Relative Motions

FIGS. 22A to 22C show schematic views 2227, 2227′, 2227″ illustrating the relative positions of AL and AH electrodes with respect to BL and BH electrodes with the electrical measurement unit coupled therebetween, and FIG. 22D shows a graph 2229 illustrating the transient current generated during the relative motion. The AL and BL electrodes are aluminium plates and AH and BH electrodes are stainless steel plates. All metal plates have a dimension of about 20 mm×about 20 mm×about 1 mm. The distance between AL and AH electrodes is fixed at about 20 mm and the distance between BL and BH electrodes is fixed at about 8.5 mm. The inner pair of the electrodes are stationary and the outer pair of electrodes move back and forth with respect to the inner pair with a speed of about 10 mm/s. The motion range is 8.5 mm.

FIG. 22A depicts the relative position between the outer pair electrodes and the inner pair electrodes where the outer pair electrodes AL, AH are positioned before moving in a direction 2235 (rightwards) or after having moved in a direction 2237 (leftwards) such that AL electrode and BH electrode are about 10 mm apart, while BL electrode and AH electrode are about 1.5 mm apart. FIG. 22B depicts the relative position between the outer pair electrodes and the inner pair electrodes, for example, after the outer pair electrodes AL, AH move in the direction 2235 (rightwards) till AL electrode and BH electrode are about 5.75 mm apart, while BL electrode and AH electrode are about 5.75 mm apart. FIG. 22C depicts the relative position between the outer pair electrodes and the inner pair electrodes after the outer pair electrodes AL, AH move further in the direction 2235 (rightwards) till AL electrode and BH electrode are about 1.5 mm apart, while BL electrode and AH electrode are about 10 mm apart, or where the outer pair electrodes AL, AH are positioned before moving (back) in the direction 2237 (leftwards) such that AL electrode and BH electrode are about 1.5 mm apart, while BL electrode and AH electrode are about 10 mm apart.

The graph 2229 of FIG. 22D traces the gap width between AL and BH electrodes (i.e. left gap in mm), as seen by line 2231, and the generated transient current in pA, as seen by curve 2233 as a function of time in seconds. Whenever the gap width is decreased from \textcircled{A} (about 10 mm), through \textcircled{B} (about 5.75 mm) to \textcircled{C} (about 1.5 mm) when moving rightwards in direction 2235 or increased from\textcircled{C}, through \textcircled{B} to \textcircled{A} when moving leftwards in direction 2237, the transient current is generated in the inner stationary pair of electrodes. The transient current is dependent on the relative motion speed, the gap width variation, and the work function difference between the two electrode materials.

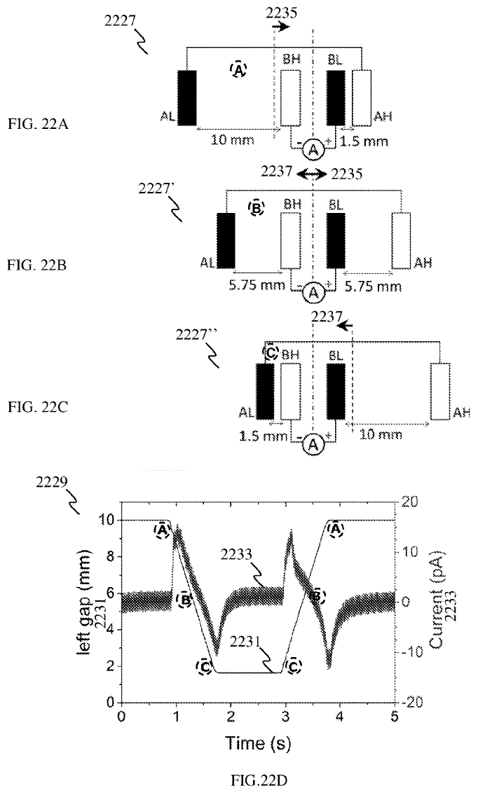

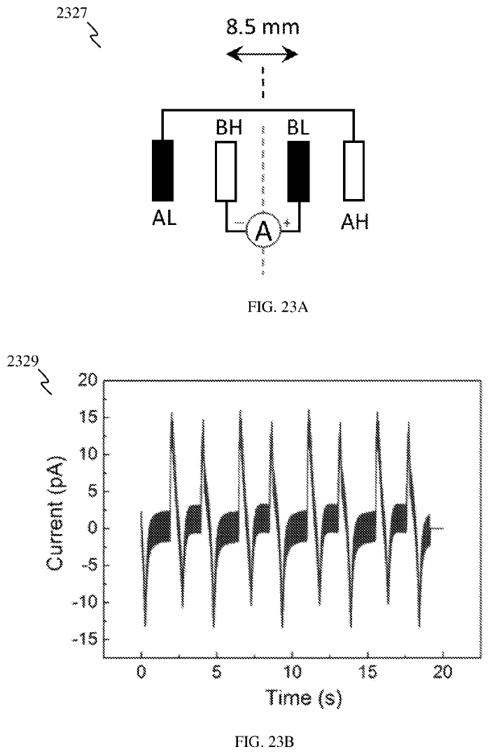

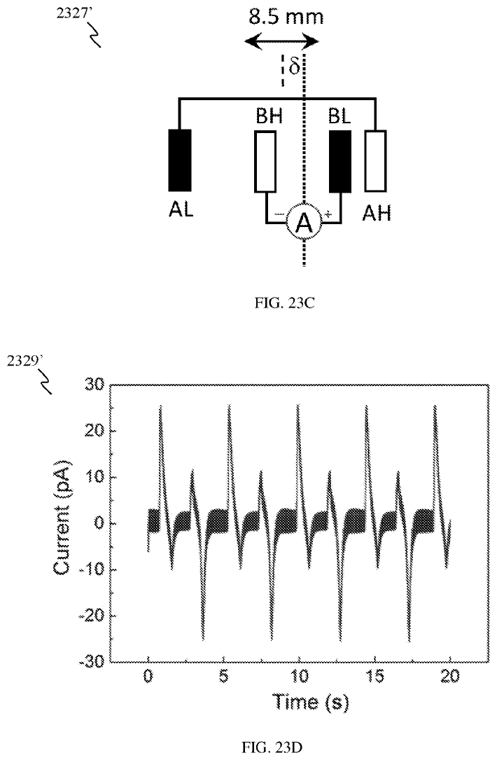

FIGS. 23A and 23C show schematic views 2327, 2327′ illustrating the relative positions of AL and AH electrodes with respect to BL and BH electrodes with the electrical measurement unit coupled therebetween. FIGS. 23B and 23D show graphs 2329, 2329′ illustrating the transient current generated during the relative motion corresponding to the schematic views of FIGS. 23A and 23C, respectively. The set-up and the relative motion speed and range are the same as those used in FIGS. 22A to 22C in that the outer pair electrodes (the movable pair, AL and AH) move with respect to the inner pair (the stationary pair, BH and BL) at a speed of 10 mm/s with a range of 8.5 mm. As seen in FIG. 23A, the centre or average centre of the movable pair (AL, AH electrodes) moves around or is overlapped with the centre of the stationary pair (BL, BH electrodes). Correspondingly, the generated current in the stationary pair caused by the relative motion of FIG. 23A is shown in FIG. 23B. As seen in FIG. 23C, the centre or average centre of the movable pair moves around the dashed line which is located with a distance 8 on the left of the dotted line where the dotted line represents the centre of the stationary/inner pair of electrodes. In effect, the centre or average centre of the movable pair is on the left of the centre of the stationary pair with a distance of δ=0.1 mm. As a result, the generated transient current shown in FIG. 23D, as caused by the relative motion of FIG. 23C, is largely different from the case in which the two centres are overlapped in FIG. 23B.

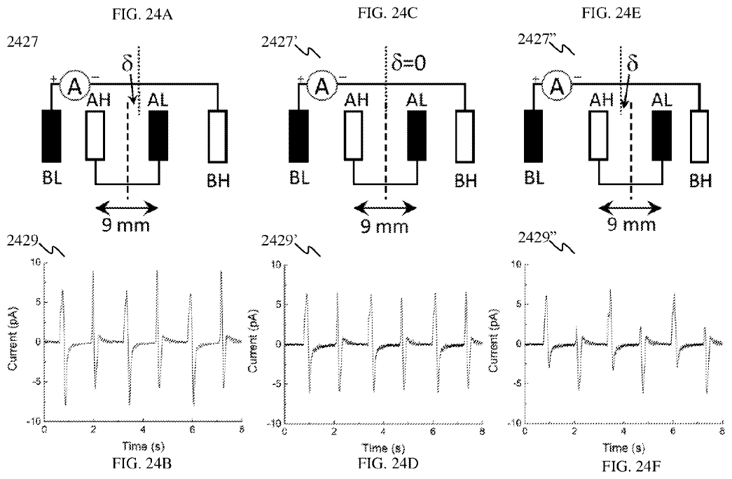

FIGS. 24A, 24C and 24E show schematic views 2427, 2427′, 2427″ illustrating the relative positions of AL and AH electrodes with respect to BL and BH electrodes with the electrical measurement unit coupled therebetween. FIGS. 24B, 24D and 24F show graphs 2429, 2429′, 2429″ illustrating the transient current generated during the relative motion corresponding to the schematic views of FIGS. 24A, 24C and 23E, respectively. AL and BL electrodes are aluminium plates and AH and BH electrodes are stainless steel plates. All metal plates have a dimension of about 20 mm×about 20 mm×about 1 mm. The distance between AL and AH electrodes is fixed at about 12 mm and the distance between BL and BH electrodes is fixed at about 25 mm. The inner (moveable) pair electrodes (AL, AH) move with respect to the outer (stationary) pair (BL, BH) at a speed of about 10 mm/s with a range of about 9 mm. FIG. 24A depicts the average centre (the dashed line) of the movable pair being on the left of the centre (the dotted line) of the stationary pair for δ=−0.2 mm. FIG. 24C depicts the average centre of the movable pair being overlapped with the centre of the stationary pair for δ=0. FIG. 24E depicts the average centre of the movable pair being on the right of the centre of the stationary pair for δ=0.2 mm. Correspondingly, the generated transient currents are shown in FIGS. 24B, 24D and 24F, caused by the relative motion of FIGS. 24A, 24C and 24E, respectively. It is clearly seen that the transient current is very much dependent on the relative positions of the two electrode pairs.

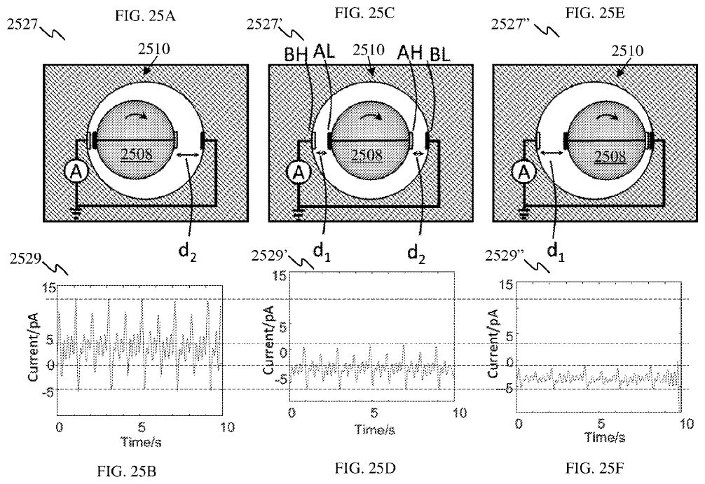

FIGS. 25A, 25C and 25E show schematic views 2527, 2527′, 2527″ illustrating the electrode installation to a rotor 2508 and stator 2510. FIGS. 25B, 25D and 25F shows graphs 2529, 2529′, 2529″ illustrating the corresponding transient current.

As shown in FIGS. 25A, 25C and 25E, AL and AH electrode pair (the movable pair) are attached to a rotor 2508 with a distance of about 5.0 cm. The rotor 2508 may be either an insulator or a conductor. In contrast, BL and BH electrodes (the stationary pair) are fixed to a stator 2510 with a distance of about 5.6 cm. In this set-up, BL electrode is grounded and BH electrode is coupled to the electrical measurement unit and then to the ground. AL and BL electrodes are aluminium plates with a thickness of about 1 mm and AH and BH electrodes are gold coated electrodes with a thickness of about 1 μm. All electrodes have an area of about 10 mm×about 10 mm. The rotor spinning speed is about 30 rpm. With d₁ increasing from about 0.2 mm (in FIG. 25A), about 1.1 mm (in FIG. 25C.) and then to about 2 mm (in FIG. 25E) (or d₂ decreasing from about 2 mm, about 1.1 mm and then to about 0.2 mm, respectively), the peak-to-peak value of the transient current decreases from about 18 pA (in FIG. 25B), about 9 pA (in FIG. 25D) to about 5 pA (in FIG. 25F), respectively. The results show the sensor may be used to detect the eccentricity of a rotor.

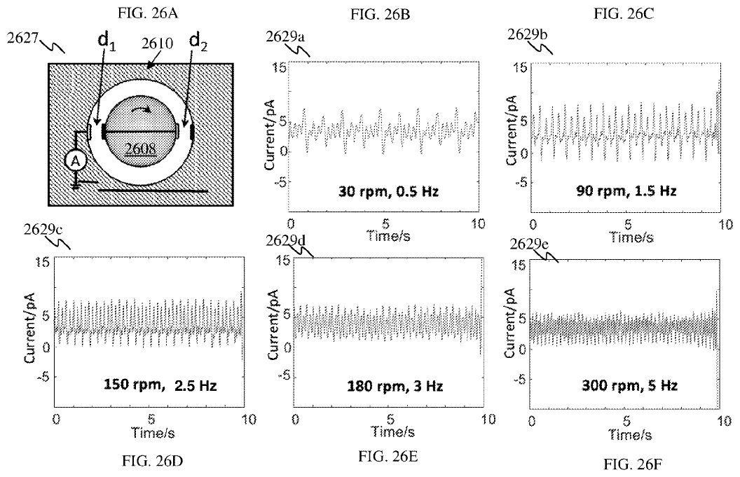

FIG. 26A shows a schematic view 2627 illustrates a set-up of the electrode installation to a rotor 2608 and stator 2610. FIGS. 26B to 26F show graphs 2629a, 2629b, 2629c, 2629d, 2629e illustrating the generated transient current in response to the spinning speed of the rotor increasing from 30 rpm to 300 rpm. It is noted that the rotor 2608 has no eccentricity where d₁=d₂=1.1 mm.

The generated transient current responds to the spinning speed of 30 rpm, 0.5 Hz (in FIG. 26B); 90 rpm, 1.5 Hz (in FIG. 26C); 150 rpm, 2.5 Hz (in FIG. 26D); 180 rpm, 3 Hz (in FIG. 26E); 300 rpm, 5 Hz (in FIG. 26F). The set-up and the electrodes are the same as those used in FIGS. 25A, 25C and 25E. The rotor 2608 in FIG. 26A has no eccentricity, and hence d₁=d₂=1.1 mm. With increasing the spinning speed from 30 rpm to 300 rpm, the frequency of the transient current peaks is consistent with the spinning speed. It is also found that with increasing the spinning speed by 10 times, the peak-to-peak value of the current is only reduced by about 28%.

### Part II. Enhancement Effect of BPDM on the Current

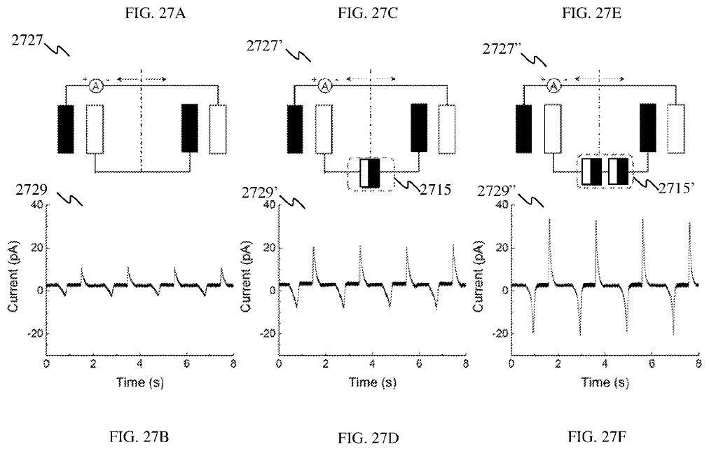

FIGS. 27A to 27F illustrate the enhancement effect of BPDM on the current, according to various examples. More specifically, FIG. 27A shows a schematic view 2727 depicting a setup with no BPDM attached to the electrode pairs, FIG. 27C shows a schematic view 2727′ depicting a setup with a BPDM constituting one metal couple 2715 attached to the moveable (inner) electrode pair, and FIG. 27E shows a schematic view 2727″ depicting a setup with a BPDM constituting two metal couples 2715′ attached to the moveable (inner) electrode pair. In FIGS. 27A, 27C and 27E, no BPDM is introduced to the stationary pair of electrodes.

The electrodes in the movable pair move together at a speed of about 10 mm/s with a range of about 3 mm with respect to the centre of the stationary (outer) pair. The stationary (outer) pair is coupled with an electrical measurement unit therebetween. FIGS. 27B, 27D, and 27F show graphs 2729, 2729′, 2729″ illustrating the generated transient currents in the stationary pair electrodes corresponding to FIGS. 27A, 27C and 27E, respectively. The peak-to-peak value of the current increases as a BPDM with more couples is employed.

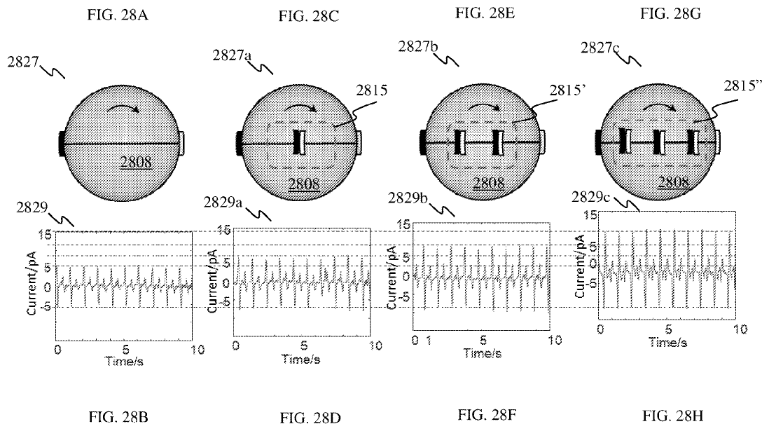

FIGS. 28A to 28H illustrate the enhancement effect of BPDM on the current, according to other examples. More specifically, FIG. 28A shows a schematic view 2827 depicting a setup with no BPDM attached to any of the electrode pairs, FIG. 28C shows a schematic view 2827a depicting a setup with a BPDM constituting one metal couple 2815 attached to the moveable electrode pair that is attached to a rotor 2808, FIG. 28E shows a schematic view 2827b depicting a setup with a BPDM constituting two metal couples 2815′attached to the moveable electrode pair that is attached to a rotor 2808, and FIG. 28G shows a schematic view 2827c depicting a setup with a BPDM constituting three metal couples 2815″ attached to the moveable electrode pair that is attached to a rotor 2808. The rotor 2808 in FIGS. 28A, 28C, 28E and 28G has no eccentricity, and hence d₁=d₂=1.1 mm. FIGS. 28B, 28D, 28F and 28H show graphs 2829, 2829a, 2829b, 2829c illustrating the generated transient currents in the stationary pair electrodes (not shown here) corresponding to FIGS. 28A, 28C, 28E and 28G, respectively. No BPDM is introduced to the stationary pair of electrodes.

The current enhancement effect may be seen when BPDM is introduced to a movable pair of electrodes which are attached to the rotor 2808 as shown in FIGS. 28A to 28H. The rotor 2808 may be either an insulator or a conductor. The BPDMs in FIGS. 28C, 28E and 28G contain a single, two and three Al/stainless steel couples, respectively. The gap between the electrodes on the rotor 2808 and stator (not shown) is about 1 mm and the eccentricity is set to zero. The peak-to-peak currents shown in FIGS. 28B, 28D, 28F and 28H are found to increase from 11 pA (in FIG. 28B) to 15 pA (in FIGS. 28D), 19 pA (in FIG. 28F) and then to 23 pA (in FIG. 28H). Electrodes AL and BL are made from Al plates and Electrodes AH and BH electrodes are made from stainless steel plates. The couples in the BPDM are simply constructed using Al plates and stainless steel plates. The plates have the same dimension of 10 mm×10 mm×1 mm.

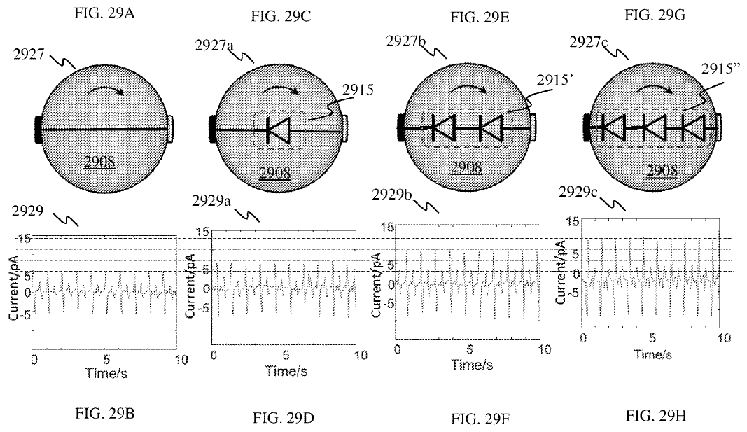

FIGS. 29A to 29H illustrate the enhancement effect of BPDM on the current, according to yet other examples. More specifically, FIG. 29A shows a schematic view 2927 depicting a setup with a primary electrode pair attached to a rotor 2908, where no BPDM is attached to the electrode pairs, FIG. 29C shows a schematic view 2927a depicting a setup with a BPDM constituting one diode 2915 attached to the moveable electrode pair, FIG. 29E shows a schematic view 2927b depicting a setup with a BPDM constituting two diodes 2915′attached to the moveable electrode pair, and FIG. 29G shows a schematic view 2927c depicting a setup with a BPDM constituting three diodes 2915″ attached to the moveable electrode pair. The rotor 2908 in FIGS. 29A, 29C, 29E and 29G has no eccentricity, and hence d₁=d₂=1.1 mm. FIGS. 29B, 29D, 29F and 29H show graphs 2929, 2929a, 2929b, 2929c illustrating the generated transient currents in the stationary pair electrodes (not shown here) corresponding to FIGS. 29A, 29C, 29E and 29G, respectively. No BPDM is introduced to the stationary pair of electrodes.

The current enhancement effect may also be seen when the metal couples in FIGS. 28C, 28E and 28G are replaced with diodes, as seen in FIGS. 29C, 29E and 29G. The electrodes of the movable pair and BPDM 2915, 2915′, 2915″ are attached to the rotor 2908. The rotor 2908 may be either an insulator or a conductor. The BPDM 2915, 2915′, 2915″ in FIGS. 29C, 29E and 29G respectively contains one, two and three diodes (Model No 1N4001). For example, the anode of diode (e.g. 2915) may be coupled to a higher work function electrode (e.g. AH) and the cathode of the diode may be coupled to a lower work function electrode (e.g. AL). The gap between the electrodes on the rotor 2908 and stator (not shown) is about 1 mm and the eccentricity is set to zero. From the generated transient currents shown in FIGS. 29B, 29D, 29F and 29H, it may be observed that the peak-to-peak current is increased from 11 pA (for no diode as seen in FIGS. 29A and 29B) to 14 pA (with one diode as seen in FIGS. 29C and 29D), 17 pA (with two diodes as seen in FIGS. 29E and 29F) and then to 21 pA (with three diodes as seen in FIGS. 29G and 29H). All electrodes are simply constructed using Al plates and stainless steel plates with the same dimension of 10 mm×10 mm×1 mm.

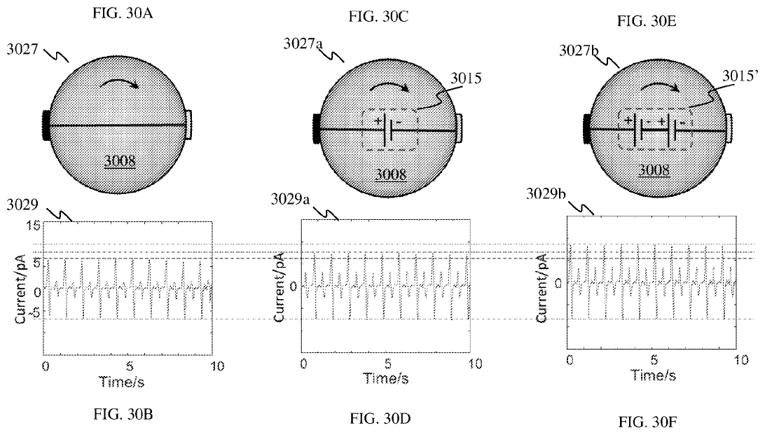

FIGS. 30A to 30F illustrate the enhancement effect of BPDM on the current, according to alternative examples. More specifically, FIG. 30A shows a schematic view 3027 depicting a setup with a primary electrode pair attached to a rotor 3008, where no BPDM is attached to the electrode pair, FIG. 30C shows a schematic view 3027a depicting a setup with a BPDM constituting one battery 3015 attached to the moveable electrode pair, and FIG. 30E shows a schematic view 3027b depicting a setup with a BPDM constituting two batteries 3015′ attached to the moveable electrode pair. The rotor 3008 in FIGS. 30A, 30C, and 30E has no eccentricity, and hence d₁=d₂=1.1 mm. FIGS. 30B, 30D, and 30F show graphs 3029, 3029a, 3029b illustrating the generated transient currents in the stationary pair electrodes (not shown here) corresponding to FIGS. 30A, 30C, and 30E, respectively. No BPDM is introduced to the stationary pair of electrodes.

The current enhancement effect may be demonstrated when batteries as BPDM 3015, 3015′ are introduced to the movable electrode pair, as shown in FIGS. 30C and 30E. The rotor 3008 may be either an insulator or a conductor. The BPDM 3015, 3015′in FIGS. 30C and 30E respectively contains one and two coin batteries (CR1616, EMF=3.2 V). For example, the negative terminal of battery (e.g. 3015) may be coupled to a higher work function electrode (e.g. AH) and the positive terminal of the battery may be coupled to a lower work function electrode (e.g. AL). The gap between the electrodes on the rotor 3008 and stator (not shown) is about 1 mm and the eccentricity is set to zero. The peak-to-peak currents shown in FIGS. 30B, 30D, and 30F are found to increase from 11 pA (for no battery as seen in FIG. 30A) to 14 pA (with one battery (3.2V) as seen in FIG. 30C), and then to 16 pA (with two batteries (6.4 V) as seen in FIG. 30E). All electrodes are simply constructed using Al plates and stainless steel plates with the same dimension of 10 mm×10 mm×1 mm.

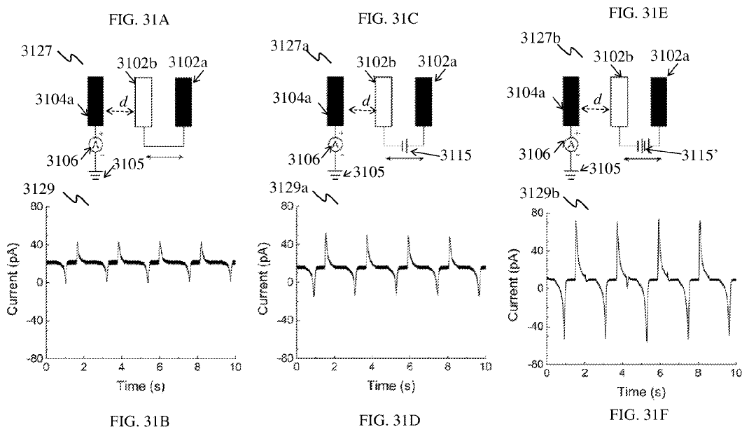

FIGS. 31A to 31F illustrate the enhancement effect of BPDM on the current, according to further alternative examples. More specifically, FIG. 31A shows a schematic view 3127 depicting a setup with no BPDM attached to any of the electrode pairs, FIG. 31C shows a schematic view 3127a depicting a setup with a BPDM constituting one AA battery 3115 attached to the moveable pair of electrodes 3102a, 3102b, and FIG. 31E shows a schematic view 3127b depicting a setup with a BPDM constituting two AA batteries 3115′ attached to the moveable pair of electrodes 3102a, 3102b. In FIGS. 31A, 31C, and 31E, the stationary electrode 3104 a is connected to the ground 3105 through an electrical measurement unit 3106. The other electrode of the stationary pair is not shown here. No BPDM is introduced to the stationary pair of electrodes (e.g. 3104a). FIGS. 31B, 31D, and 31F show graphs 3129, 3129a, 3129b illustrating the generated transient currents between the stationary electrode 3104a and the ground 3105 corresponding to FIGS. 31A, 31C, and 31E, respectively.

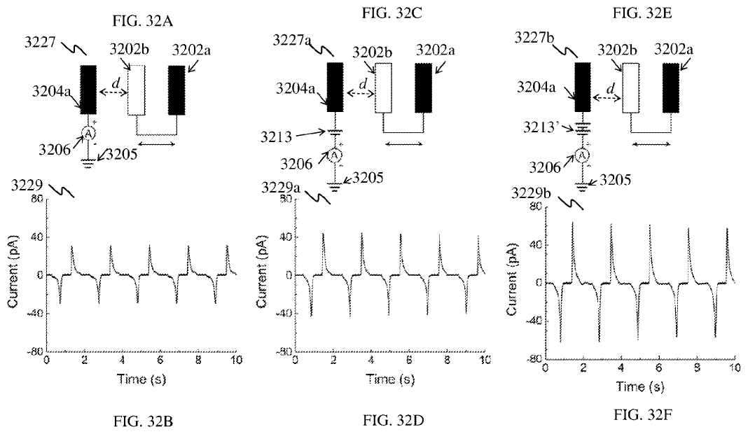

FIGS. 32A to 32F illustrate the enhancement effect of BPDM on the current, according to yet further alternative examples. More specifically, FIG. 32A shows a schematic view 3227 depicting a setup with no BPDM attached to any of the electrode pairs, FIG. 32C shows a schematic view 3227a depicting a setup with a BPDM constituting one AA battery 3213 attached to the stationary electrode 3204a, and FIG. 32E shows a schematic view 3227b depicting a setup with a BPDM constituting two AA batteries 3213′ attached to the stationary electrode 3204a. In FIG. 32C, and 32E, the stationary electrode 3204a is connected to the ground 3205 through the BPDM 3213, 3213′ and an electrical measurement unit 3206. The other electrode of the stationary pair is not shown here. No BPDM is introduced to the moveable electrodes 3202a, 3202b. FIGS. 32B, 32D, and 32F show graphs 3229, 3229a, 3229b illustrating the generated transient currents between the stationary electrode 3204a and the ground 3205 corresponding to FIGS. 32A, 32C, and 32E, respectively.

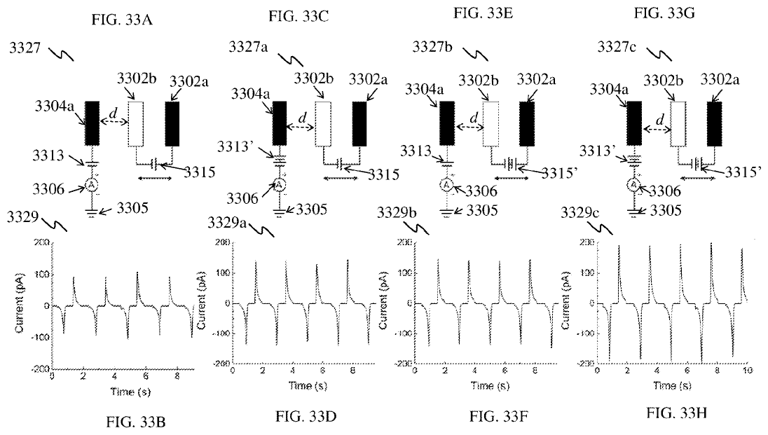

FIGS. 33A to 33H illustrate the enhancement effect of BPDM on the current according to various combinational examples. More specifically, FIG. 33A shows a schematic view 3327 depicting a setup with a BPDM constituting one AA battery 3313 attached to the stationary electrode 3304a and another BPDM constituting one AA battery 3315 attached to the moveable electrode pair 3302a, 3302b, FIG. 33C shows a schematic view 3327a depicting a setup with a BPDM constituting two AA batteries 3313′attached to the stationary electrode 3304a and the other BPDM constituting one AA battery 3315 attached to the moveable electrode pair 3302a, 3302b, FIG. 33E shows a schematic view 3327b depicting a setup with the BPDM constituting one AA battery 3313 attached to the stationary electrode 3304a and another BPDM constituting two AA batteries 3315′ attached to the moveable electrode pair 3302a, 3302b, and FIG. 33G shows a schematic view 3327c depicting a setup with the BPDM constituting two AA batteries 3313′ attached to the stationary electrode 3304a and the other BPDM constituting two AA batteries 3315′ attached to the moveable electrode pair 3302a, 3302b. In FIGS. 33A, 33C, 33E, and 33G, the stationary electrode 3304a is connected to the ground 3305 through the BPDM 3313, 3313′ and an electrical measurement unit 3306. FIGS. 33B, 33D, 33F and 33H show graphs 3329, 3329a, 3329b, 3329c illustrating the generated transient currents between the stationary electrode 3304a and the ground 3305 corresponding to FIGS. 33A, 33C, 33E, and 33G, respectively.

Batteries used as BPDM are introduced into the linear moveable electrode pair 3102a, 3102b as seen in FIGS. 31C and 31E, to the stationary electrode 3204a as seen in FIGS. 32C and 32E, and to both moveable electrodes 3302a, 3302b as well as the stationary electrode 3304a as seen in FIGS. 33A, 33C, 33E and 33G. In these experiments, AA batteries with an EMF=1.5 V are used. The moveable electrodes 3102a, 3102b, 3202a, 3202b, 3302a, 3302b move forward and backward with respect to the centre position of the two electrodes 3102a, 3102b, 3202a, 3202b, 3302a, 3302b (as denoted by the solid bi-directional arrows) at a speed of about 10 mm/s and in a range of about 4.5 mm. The gap width d between the stationary electrode 3104a, 3204a, 3304a and the moveable electrode 3102b, 3202b, 3302b changes between 1 mm and 5.5 mm. Aluminium plates (in black as seen for 3104a, 3102a, 3204a, 3202a, 3304a, 3302a) and stainless steel plates (in white as seen for 3102b, 3202b, 3302b) are used as the lower and higher work function electrodes, respectively. All metal electrodes have a dimension of 10 mm×10 mm×1 mm.

FIG. 31B shows the transient current obtained from the set-up shown in FIG. 31A. There is no battery in between the two electrodes of the moveable pair 3102a, 3102b and between the stationary electrode 3104a and the ground 3105. It is seen that the peak-to-peak current is about 40 pA. After one and two batteries are introduced to the moveable electrode pair 3102a, 3102b in FIGS. 31C and 31E, respectively, the peak-to-peak current increases to 75 pA (in FIGS. 31D) and 120 pA (in FIG. 31F), respectively. A similar current enhancement effect may be observed when the batteries are introduced in between the stationary electrode 3204a and the ground 3205, rather than in between the moveable electrode pair 3202a, 3202b, as shown in FIGS. 32C and 32E. After two batteries 3315′ are added to the moveable electrode pair 3302a, 3302b and two batteries 3313′ are introduced in between the stationary electrode 3304a and the ground 3305 (in FIG. 33G), the peak-to-peak current is nearly 400 pA (FIG. 33H), increasing by a factor of 10 in comparison with the case where no battery is introduced in the electrode connections at all (compared with FIG. 31B).

The sensor may be self-powered through mechanical to electric power conversion. In other words, the induced currents measurable by the one or more electrical measurement units are generated by mechanical to electric power conversion. The induced electrical signals, e.g. induced current signals, can be enhanced by incooperating one or more passive BPDMs in the primary sensing pair and/or the secondary sensing pair. FIGS. 9A, 9B, 10, 12A, 12B, 13, 22A to 22 D, 23A to 23D, 24A to 24F, 25A to 25F, 26A to 26F, 27A to 27F, 28A to 28H, 29A to 29H, 30A, 30B, 31A, 31B, 32A, and 32B are directed at the induced electrical signals, for example, induced current signals, being generated and enhanced by self-power.

Alternatively, the sensor may be externally powered to enhance the induced electrical signals, e.g. induced currents, measurable by the one or more electrical measurement units. The external power sources may be batteries, rechargeable batteries, capacitors or other kinds of voltage sources. The external power may be incooperated in the sensor as one or more active BPDMs in the primary sensing pair and/or the secondary sensing pair. FIGS. 11, 14, 30C to 30F, 31C to 31F, 32C to 32F and 33A to 33H are directed at the induced electrical signals, for example, induced currents, being enhanced by battery based BPDMs.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A sensor comprising:
a primary sensing part comprising a first electrode and a second electrode electrically coupled to the first electrode, wherein the first electrode comprises a first material and the second electrode comprises a second material;
a secondary sensing part comprising a third electrode and a fourth electrode electrically coupled to the third electrode, wherein the third electrode comprises a third material, and the fourth electrode comprises a fourth material,
the first material, the second material, the third material and the fourth material being either different from one another or the same; and
one or more electrical measurement units each electrically coupled to:
the third electrode, or
the fourth electrode, or
both the third electrode and the fourth electrode, or
the first electrode, or
the second electrode, or
both the first electrode and the second electrode;
wherein the primary sensing part and the secondary sensing part are free from electrical connection with each other; and
wherein at least one of the first electrode or the second electrode of the primary sensing part and at least one of the third electrode or the fourth electrode of the secondary sensing part are arranged to move relatively to each other to generate one or more electrical signals measurable by the one or more electrical measurement units, the generated one or more electrical signals being representative of at least one quantifiable parameter of relative motion between the primary sensing part and the secondary sensing part.

2. The sensor as claimed in claim 1, wherein the sensor is a self-powered sensor; or an externally powered sensor.

3. The sensor as claimed in claim 1-or 2, wherein each of the first electrode, the second electrode, the third electrode and the fourth electrode comprises more than one material.

4. The sensor as claimed in claim 1, wherein each of the first material, the second material, the third material and the fourth material comprises metals, or semiconductors, or ferroelectric materials, or pyroelectric materials, or a combination of at least one of the metals, or the semiconductors, or the ferroelectric materials, or the pyroelectric materials.

5. The sensor as claimed in claim 1, wherein the first electrode is arranged to be positioned spaced apart from and facing to the fourth electrode, and/or the second electrode is arranged to be positioned spaced apart from and facing to the third electrode.

6. The sensor as claimed in claim 1, wherein the one or more electrical measurement units, and at least one of the first electrode, the second electrode, the third electrode or the fourth electrode are arranged in one of the following configurations:
(i) one of the one or more electrical measurement units is electrically coupled between a ground and one of the third electrode or the fourth electrode; and/or
another of the one or more electrical measurement units is electrically coupled between the ground and the other of the third electrode or the fourth electrode; or
(ii) one of the one or more electrical measurement units is electrically coupled between a ground and one of the first electrode or the second electrode; and/or
another of the one or more electrical measurement units is electrically coupled between the ground and the other of the first electrode or the second electrode; or
(iii) one of the one or more electrical measurement units is electrically coupled between the third electrode and the fourth electrode; and/or between the first electrode and the second electrode.

7. The sensor as claimed in claim 6, wherein
each of the one or more electrical measurement units conditions or measures or both conditions and measures the generated one or more electrical signals; and
each of the one or more electrical measurement units has either:
single-ended inputs comprising an input and the ground, or differential inputs comprising a non-inverting input and an inverting input,
wherein
for the single-ended inputs, one of the first electrode or the second electrode is connected to the input, and the other of the first electrode or the second electrode is connected to the ground or unconnected, and/or
one of the third electrode or the fourth electrode is connected to the input, and the other of the third electrode or the fourth electrode is connected to the ground or unconnected, and
for the differential inputs, one of the first electrode or the second electrode is connected to the non-inverting input, and the other of the first electrode or the second electrode is connected to the inverting input, and/or
one of the third electrode or the fourth electrode is connected to the non-inverting input, and the other of the third electrode or the fourth electrode is connected to the inverting input.

8. The sensor as claimed in claim 1,
wherein the first electrode is arranged to be positioned spaced apart from and facing to the fourth electrode, and the third electrode is arranged to be connected to a ground; or
wherein the second electrode is arranged to be positioned spaced apart from and facing to the third electrode, and the fourth electrode is arranged to be connected to the ground.

9. The sensor as claimed in claim 1,
wherein the first electrode, or the second electrode, or both the first electrode and the second electrode each has a front surface coated with passivation layers, the front surface being a surface arranged to be respectively positioned facing to the fourth electrode, and/or to the third electrode; and
wherein the third electrode, or the fourth electrode, or both the third electrode and the fourth electrode each has a frontal surface coated with passivation layers, the frontal surface being a surface arranged to be respectively positioned facing to the second electrode, and/or to the first electrode.

10. The sensor as claimed in claim 1, further comprising a built-in potential difference multiplier electrically coupled to the first electrode and the second electrode of the primary sensing part; and/or electrically coupled to the third electrode and the fourth electrode of the secondary sensing part.

11. (canceled)

12. The sensor as claimed in claim 10, wherein the built-in potential difference multiplier comprises one of the following:
one or more components coupled in series, each component comprising a first portion including a metal, or a semiconductor, or a ferroelectric material, or a pyroelectric material, or a functionalized material; and a second portion including another metal, or another semiconductor, or another ferroelectric material, or another pyroelectric material, or another functionalized material, wherein the second portion is adjacent to the first portion; or
one or more diodes coupled in series; or
one or more energy storage devices coupled in series.

13. The sensor as claimed in claim 12, further comprising an insulating spacer arranged between each component of the one or more components and a neighboring component of the one or more components, and/or in each component, an interlayer arranged between the first portion and the second portion.

14. A method for determining at least one quantifiable parameter of relative motion between a movable object and a stationary object or another movable object, the method comprising:
providing a sensor comprising:
a primary sensing part comprising a first electrode and a second electrode electrically coupled to the first electrode, wherein the first electrode comprises a first material and the second electrode comprises a second material;
a secondary sensing part comprising a third electrode and a fourth electrode electrically coupled to the third electrode, wherein the third electrode comprises a third material, and the fourth electrode comprises a fourth material; the first material, the second material, the third material and the fourth material being either different from one another or the same; and
one or more electrical measurement units each electrically coupled to:
the third electrode, or
the fourth electrode, or
both the third electrode and the fourth electrode, or
the first electrode, or
the second electrode, or
both the first electrode and the second electrode,
wherein the primary sensing part and the secondary sensing part are free from electrical connection with each other;
attaching at least one portion of the primary sensing part to the movable object;
attaching at least one portion of the secondary sensing part to the stationary object or the other movable object with the third electrode positioned facing towards the second electrode of the primary sensing part, and/or with the fourth electrode positioned facing towards the first electrode of the primary sensing part; and
measuring, by the one or more electrical measurement units, one or more electrical signals generated in the sensor, wherein the generated one or more electrical signals are representative of the at least one quantifiable parameter of relative motion between the primary sensing part and the secondary sensing part.

15. The method as claimed in claim 14, wherein the movable object comprises a rotor of a motor, the stationary object comprises a stator of the motor, and wherein measuring the one or more electrical signals comprises measuring the one or more electrical signals representative of at least one of a rotational speed or an eccentricity of the rotor.

16. The method as claimed in claim 15, further comprising:
providing one or more other secondary sensing parts; each of the one or more other secondary sensing parts including two electrodes electrically coupled to each other;
providing one or more other electrical measurement units electrically coupled to at least one of the two electrodes in each of the one or more other secondary sensing parts; and
measuring, by the one or more other electrical measurement units, one or more other electrical signals generated in each of the one or more other secondary sensing parts,
wherein the one or more other secondary sensing parts are attached to the stator with each of the secondary sensing part and the one or more other secondary sensing parts arranged angularly spaced apart from one another; and
wherein the one or more electrical signals measured by the one or more electrical measurement units in the secondary sensing part and the one or more other electrical signals measured by each of the one or more other secondary sensing parts are used to determine the eccentricity of the rotor in two or more different directions.

17. The method as claimed in claim 15,
wherein providing the sensor comprises
providing one or more electrodes attached to the stator with each of the electrodes arranged angularly spaced apart from each other;
providing one electrical measurement unit electrically coupled to each of the electrodes through a ground; and
wherein measuring the electrical signal generated in between each of the electrodes and the ground, by the electrical measurement unit,
the electrical signals measured by each of the electrical measurement units being used to determine the eccentricity of the rotor in the one or more than one direction and the rotation speed.

18. The method as claimed in claim 14, wherein the movable object comprises a vibrational beam, and wherein measuring the one or more electrical signals comprise measuring the one or more electrical signals representative of at least one of a vibration amplitude or a frequency of the vibrational beam with respect to the stationary object or the other movable object.

19. The method as claimed in claim 18, wherein attaching the at least one portion of the primary sensing part to the movable object comprises attaching both the first electrode and the second electrode to the vibrational beam and including one of the following:
arranging the first electrode or the second electrode between the third electrode and the fourth electrode of the secondary sensing part, while having the third electrode or the fourth electrode arranged between the first electrode and the second electrode, in a comb manner; or
arranging the first electrode and the second electrode in between the third electrode and the fourth electrode of the secondary sensing part; or
arranging the third electrode and the fourth electrode of the secondary sensing part in between the first electrode and the second electrode.

20. The method as claimed in claim 14, wherein the sensor comprises the sensor as claimed in claim 1.
